(19) United States
(12) Patent Application Publication
(10) Pub. No.: US 2024/0256920 A1
(43) Pub. Date: Aug. 1, 2024

(54) SYSTEMS AND METHODS FOR FEATURE ENGINEERING

(71) Applicant: FeatureByte, Inc., Shrewsbury, MA (US)

(72) Inventors: Xavier S. Conort, Singapore (SG); Hon Nian Chua, Singapore (SG); Sergey Yergenson, Marlborough, MA (US)

(21) Appl. No.: 18/430,135

(22) Filed: Feb. 1, 2024

Related U.S. Application Data
(60) Provisional application No. 63/482,662, filed on Feb. 1, 2023.

(51) Int. Cl. G06N 5/022; G06F 16/22; G06F 16/25

(52) U.S. Cl. CPC G06N 5/022; G06F 16/2282; G06F 16/258

(57) ABSTRACT

A method includes performing automated feature discovery with respect to a first entity and a view. The view is associated with a table derived from source data. The table includes columns representing data fields having assigned semantic types. The automated feature discovery includes selecting transformation operations to be applied to the table based on a data type of the view, an entity type of the first entity, entity types of second entities related to the first entity, entity relationships between the first entity and the second entities, descriptive statistics characterizing values in columns of the table, and/or a semantic type assigned to a column of the table. The method further includes generating one or more features based on the view, wherein generating the features includes applying the selected transformation operations to the table, and storing the generated features in a feature catalog.

### CROSS REFERENCE TO RELATED APPLICATION

This application claims priority and benefit under 35 U.S.C. § 119(e) of U.S. Provisional Patent Application No. 63/482,662, titled “Systems and methods for feature engineering” and filed Feb. 1, 2023, the entire contents of which are hereby incorporated herein by reference.

### FIELD OF TECHNOLOGY

The present disclosure relates generally to feature engineering and, more specifically, to systems and methods for deriving and serving features suitable for training and operating artificial intelligence systems (e.g., for particular use cases).

### BACKGROUND

Artificial intelligence models and related systems may be configured to generate output data (e.g., predictions, inferences, and/or content) based on input data aggregated from a number of data sources (e.g., source tables). Training and using an artificial intelligence model (e.g., a machine-learning model) to generate output data based on input data can involve a number of steps. Data sources (e.g., raw data) can be identified and processed to create source data (e.g., tables), which can indicate the attributes of various entities (e.g., at various times). The source data may contain features of interest, and/or such features may be generated by performing one or more data transformations on the source data. The processes of generating and/or identifying such features may be referred to as “feature engineering” and/or “feature selection.” During a model training process, sets of features can be used to train a model to provide the desired output data. After the model has been trained, similar sets of features can be provided as input to the model, which can then generate the corresponding output data.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

According to aspect of the present disclosure, a computer-implemented method for generating an observation data set is provided. The method includes receiving an indication of a context and an indication of an observation time period; and generating a sample set of entity instances associated with the context and the observation time period. Generating the sample set includes selecting a first subset of entity instances from a plurality of entity instances, each entity instance in the first subset of entity instances being associated with the context and with one or more timestamps that intersect the observation time period; and selecting a second subset of entity instances from the first subset of entity instances based on the one or more timestamps associated with the first subset of entity instances, wherein the second subset of entity instances is the sample set of entity instances. The method further includes generating an observation data set associated with the context and the observation time period based on the sample set of entity instances; and providing the observation data set to a device configured to train or use a model to make predictions based on the observation data set.

According to another aspect of the present disclosure, a computer-implemented method for populating a feature catalog is provided. The method includes registering source data from a plurality of data sources; populating a feature catalog, wherein populating the feature catalog includes generating a plurality of features based on the source data, wherein generating each feature in the plurality of features comprises applying one or more data transformations associated with the feature to a respective subset of the source data. The method further includes, for each feature in the feature catalog: determining one or more signal types of the feature based at least in part on data indicating semantic types of one or more fields of the source data used to generate the feature and the one or more data transformations associated with the feature, wherein the semantic types of the one or more fields are selected from a plurality of semantic types defined by a data ontology; and associating the feature with the one or more signal types in the feature catalog.

According to another aspect of the present disclosure, a computer-implemented feature discovery method is provided. The method includes performing automated feature discovery with respect to a first entity and a view, wherein the view is associated with a table derived from source data, wherein the table includes a plurality of columns, wherein each column of the table represents a data field having an assigned semantic type. Performing the automated feature discovery includes selecting one or more transformation operations to be applied to the table based on a data type of the view, an entity type of the first entity, entity types of one or more second entities related to the first entity, one or more entity relationships between the first entity and the one or more second entities, one or more descriptive statistics characterizing values in one or more columns of the table, and/or a semantic type assigned to a column of the table; generating one or more features based on the view, wherein generating the one or more features comprises applying the one or more selected transformation operations to the table; and storing the one or more generated features in a feature catalog.

The foregoing Summary is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a block diagram of an exemplary feature engineering control platform, in accordance with some embodiments.

FIG. 2 is a flow diagram of an example method for generating a data set, in accordance with some embodiments.

FIG. 3 is a flow diagram of an example method for automatically determining a signal type of a feature, in accordance with some embodiments.

FIG. 4 is a flow diagram of an example method for automated feature discovery, in accordance with some embodiments.

FIG. 5 is a block diagram of an example computer system, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

Systems and methods for feature engineering are described herein. It will be appreciated that, for simplicity and clarity of illustration, where considered appropriate, reference numerals may be repeated among the figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details.

### Terms

In certain examples, “data analytics” may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

In certain examples, “machine learning” generally refers to the application of certain techniques (e.g., pattern recognition and/or statistical inference techniques) by computer systems to perform specific tasks. Machine learning techniques (automated or otherwise) may be used to build data analytics models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

In certain examples, “source data” can refer to data received from data sources (e.g., source tables) connected to a data warehouse of the feature engineering control platform. In some cases, source data may include tabular data (e.g., one or more tables) including one or more rows and one or more columns. Users may identify (e.g., annotate and/or tag) columns of a table to define key(s) for the table during registration of data sources (e.g., source tables). In some cases, source data may include one or more records (e.g., one or more rows of a table), where each record or set of records includes and/or is otherwise associated with a timestamp. A record included in the source data (e.g., a table) may be immutable. When information included in records of source data (e.g., a table) changes, the changes may be tracked in a corresponding slowly changing dimension table. If records of the source data (e.g., table) are overwritten without keeping historical records, the source data may not be a suitable candidate for feature engineering based on the changes potentially causing (1) severe data leaks during training of an artificial intelligence model; and/or (2) poor performance of inferences generated by an artificial intelligence model.

Source data can include, for example, time-series data, event data, sensor data, item data, slowly changing dimension data, dimension data, etc. In certain examples, “time-series data” (e.g., “time-series table”) can refer to data (e.g., tabular data) collected at successive, regularly spaced (e.g., equally spaced) points in time. In some cases, rows in a time-series data table may represent an aggregated measure over the time unit (e.g., daily sales) and/or balances at the end of a time period. In some cases, records may be missing from a time-series data table and the time unit (e.g., hour, day, month, year) of the time-series data table may be assumed to be constant over time. Other data associated with timestamps and collected at irregularly spaced points in time may be referred to as “sensor data” (e.g., “sensor table”) or “event data” (e.g., “event table”). A row in a sensor table may be representative of a measurement that occurs at predictable intervals. A row in an event table may be representative of a discrete event (e.g., business event) measured at a point-in-time.

In certain examples, a “view” and/or “view object” can refer to a data object derived from source data (e.g., a table) based on applying at least one data transformation to the source data. Examples of views can include an event view derived from an event table, an item view derived from an item table, a time-series view derived from a time-series table, a slowly changing dimension view derived from a slowly changing dimension table, a dimension view derived from a dimension table, etc.

In certain examples, “primary table” of a feature can refer to the table associated with a view from which the feature has been derived. When the view is enriched by the joins of other table views, the other source data may be referred to as the “secondary table” of the feature.

In certain examples, an “entity” can refer to a thing (e.g., a physical, virtual, or logical thing) that is uniquely identifiable (e.g., has a unique identity), or to a class of such things. In some examples, an entity may be used to define, serve, and/or organize features. For example, an entity may be used to define a use case of an artificial intelligence model. An “entity type” can refer to a class of entities that share a particular set of attributes. Some non-limiting examples of physical entity types can include customer, house, and car. Some non-limiting examples of logical or virtual entity types can include merchant, account, credit card, and event (e.g., transaction or order). An “entity instance” can refer to an individual occurrence of an entity type. As used herein, the term “entity” can refer to an entity type and/or to an entity instance, consistent with the context in which the term is used. In some examples, an entity (e.g., an entity type or an entity instance) may be associated with or correspond to a set of source data (e.g., a table, a row of a table (“record”), or a column of a table (“field”)).

One non-limiting example of an entity type is an “event entity,” which represents an event. In some examples, event entities include data indicating a time associated with the event (e.g., a timestamp indicating when the event occurred) or a duration of the event (e.g., a start timestamp indicating a time when the event started and an end timestamp indicating a time when the event ended). For example, an event entity representing a purchase transaction may have a single timestamp indicating when the transaction occurred, while an entity representing a browsing session may have start and end timestamps indicating when the browsing session started and ended. The difference between the end timestamp and the start timestamp of an event entity may indicate a duration of the event. Event entities are described in greater detail below.

In certain examples, an “entity relationship” can refer to a relationship that exists between two entities. A “child-parent relationship” can be established when the instances of the child entity are uniquely associated with the parent entity instance. For example, for an organization, the Employee entity can be a child of the Department entity. A “subtype-supertype relationship” can be established when the instances of the subtype entity are a subset of the instances of the supertype entity. For example, the Employee entity can be a subtype of the Person entity and the Customer entity can be a subtype of the Person entity.

In certain examples, a “feature” can refer to an attribute of an entity derived from source data (e.g., a table). A feature can be then provided as an input to an artificial intelligence model associated with this entity for training and production operation of the artificial intelligence model. Features may be generated based on view(s), and/or other feature(s) as described herein. In some cases, features may use attributes available in views. For example, a customer churn model may use features directly extracted from a customer profile table representing customer's demographic information such as age, gender, income, and location. In some cases, features can be derived from a series of row transformations, joins, and/or aggregates performed on views. For example, a customer churn model may use aggregated features representing a customer's account information such as the count of products purchased, the count of orders canceled, and the amount of money spent. Other examples of features representing a customer's behavioral information can include the number of the customer complaints per type of complaints and the timing of the customer interactions. In some cases, features can be derived using one or more user-defined transformation functions. For example, transformer-based models or large language models (LLMs) can be encapsulated in user-defined transformation functions, which can be used to generate embeddings (e.g., text embeddings).

Features can also have data types. For example, a feature can have a numerical data type, a date-time type, a text data type, a categorical data type, a dictionary data type, or any other suitable data type.

In certain examples, a “feature job” can refer to the materialization of a particular feature and its storage in an online feature store to serve model inferences. A feature job may be scheduled on a periodic basis with a particular frequency, execution timestamp, and blind spot as described herein.

In certain examples, a “feature request” can refer to the serving of a feature. Types of feature requests can include a historical feature request and an online feature request. Historical requests can be made to generate training data to train and/or test models. Online requests can be made to generate inference data to generate output data.

In certain examples, a “point-in-time” can refer to a time when an online feature request is made for model inference.

In certain examples, a “point-in-time” may be used in the context of a historical feature request. For a historical feature request, “point-in-time” can refer to the time of past simulated requests encapsulated in the historical feature request data. A historical feature request data may typically be associated with a large number of “points-in-time”, such that models can learn from a large variety of circumstances.

In certain examples, an “observation set” can refer to request data of a historical feature request. The observation set can provide the entity instances from which the model can learn together with the past points-in-time associated with each entity instance. The sampling of the entity instances and the choice of their points-in-time can be carefully made to avoid biased predictions or overfitting. For example, for a model to predict customer churn in the next 6 months, the points-in-time can cover a period of at least one year to ensure all seasons are represented and the customer instances (e.g., customer identifier values) can be drawn from the population of customers active as at the points-in-time to prevent bias. For the same example, the time interval between two points-in-time for a given customer instance can be larger than 6 months (e.g., the churn horizon) to prevent leaks.

In certain examples, a “context” can refer to circumstances in which feature(s) are expected to be served. A context may include an indication of at least one entity with which the context is related, a context name, and/or a description. In some cases, a context may include an expected inference time or an expected inference time period for the context and a context view that can mathematically define the context. For example, for a model that predicts customer churn, the context entity is customer, the context's description may be active customer, and the context's expected inference time may be every Monday between 2 am and 3 am. A context view for the context may be a table of the customer instances together with their periods of activity.

In certain examples, a “use case” can refer to a modeling problem to be solved. The modeling problem of a use case may be solved by an artificial intelligence model, such as a machine-learning model. A use case may be associated with a context and a target for which the artificial intelligence model learns to generate output data (e.g., predictions). In some cases, the target may be defined based on a target recipe that can be served together with features during historical feature requests. For example, for a model that predicts customer churn, the target recipe may retrieve a Boolean value that indicates the customer churn within 6 months after the points-in-time of the historical feature request. The target recipe can be used to track the accuracy of predictions generated by the artificial intelligence model in production.

As used herein, “data analytics model” may refer to any suitable model artifact generated by the process of using a machine learning algorithm to fit a model to a specific training data set. The terms “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. As used herein, the “deployment” of a machine learning model may refer to the use of a developed machine learning model to generate inferences about data other than the training data.

### Motivation for and Benefits of Some Embodiments

There is a large and growing market for machine learning (ML)/artificial intelligence (AI) models that can generate predictions, inferences, and/or content. Some examples of industries and applications of ML/AI models include the automotive industry (e.g. self-driving cars), healthcare industry (e.g., medical devices, health monitoring software, etc.), manufacturing and supply-chain industries (e.g., industrial automation), robotics, etc. Additionally, the field of marketing significantly benefits from ML/AI, with applications in customer behavior analysis, personalized content creation, predictive analytics for market trends, and automation of digital marketing campaigns. These advancements in ML/AI are revolutionizing how businesses interact with and understand their customers.

However, the process of building high-quality models can be difficult, expensive, and time-consuming. Initially, data sources of interest can be identified or obtained, and features of interest can be generated from the data sources using feature engineering techniques. Although many aspects of data identification and feature engineering are often performed manually, feature pipelines may be used to generate and serve data sets containing engineered features. Such data sets can be used as training data in a model-training process or provided as input data (e.g., “inference data” or “production data”) to a trained model which can generate output data based on the input data.

In the past decade, there have been advances in automated machine learning (“AutoML”) technology, which have made it easier to build models based on a given set of features. However, given the enormous amount of data available, and the almost-endless ways in which data sources can be combined and transformed to generate new features, the ‘solution space’ for feature discovery, engineering, and selection is enormous, and choosing a suitable set of features for a use case largely remains a manual, labor-intensive, intuition-driven process of trial-and-error. Finding the best solutions tends to require a combination of domain knowledge and data science expertise that few individuals possess. Some automated feature engineering techniques have been developed, but many of these techniques tend to generate a large number of features that have little or no relevance to the problems that users are attempting to solve. Thus, there is a need for more efficient, rigorous, data-driven systems and methods for identifying feature candidates.

Described herein are embodiments of feature engineering systems that use efficient, rigorous, data-driven techniques to identify the best feature candidates in the vast feature solution space for a user-specified use case. In some examples, such feature engineering systems can automatically suggest features (e.g., existing features from a feature catalog and/or new features that can be generated from available data sources) suitable for a specified use case. In some examples, feature discovery processes (e.g., automatically selecting one or more features for use in training a model, or recommending one or more features for such use; automatically generating a new feature by performing one or more data transformations on source data and/or existing features, or recommending the generation of such new features, etc.) are guided by characterizations of available data objects (e.g., source data, tables, views, features, etc.), such that better feature candidates in the feature solution space are selected, generated, or recommended by the system, and worse feature candidates are not selected, generated, or recommended. Some examples of suitable characterizations of data objects can include data indicating semantic types assigned to fields of source data, signal types or data types assigned to features, lineage of features, entity types associated with different tables of source data and the relationships among those entities, data types of views of the source data, etc. For example, a feature engineering system can limit the types of data transformation operations automatically applied to or recommended for a set of data objects during a feature discovery process based on the characterizations of the data objects.

Aside from the challenges associated with efficiently identifying high-quality feature candidates, conventional feature engineering techniques generally exhibit several deficiencies. Some non-limiting examples of such difficulties can include (1) accessing correct raw data sources (e.g., source tables) for aggregating raw data; (2) building and generating features from aggregated raw data; (3) combining generated features into training data used to train the artificial intelligence model; (4) materializing and serving features in production when the artificial intelligence model is deployed; and (5) monitoring features in production for irregularities and discrepancies, such as feature drift and missing data sources (e.g., source tables). Accordingly, there is a need for improved techniques for generating and serving features for artificial intelligence models and related systems.

In some examples, the techniques described herein may streamline feature extraction from source data by recommending aggregation and feature extraction schedules that are consistent or synchronized with the usual update patterns of the source data. By calculating optimized time frames for feature computation, these techniques can significantly reduce the instances of delayed data. In some examples, this systematic and timely approach to feature extraction not only maintains the integrity of the data used in model inference but also provides consistency between the features used during training and those employed during model inference. Such consistency and/or synchronization can be crucial for the development of reliable and accurate machine learning models.

Features extracted from source data and/or from other features can be stored in a feature catalog. In some examples, signal types can be automatically derived and assigned to the features to facilitate aspects of feature engineering. For example, the feature catalog can be searched by signal type to facilitate the efficient identification of high-quality features relevant to a use case, and the identified features can be used to train machine learning models, develop insights into the data, and/or generate additional features.

The feature catalog may be queried for a data set (e.g., “observation set”) representing a collection of entity instances and their corresponding historical timestamps. Such data sets can be used to compute features that constitute the training data for machine learning models. To ensure the models learn effectively, it can be crucial that these data sets not only pertain to the model's intended application but also match the real-world conditions that the models are expected to encounter during inference. In some examples, the techniques described herein can be used to generate such data sets in a way that is both unbiased and accurate, thereby significantly reducing or even eliminating the risk of data leakage. This careful curation and preparation of data sets can greatly facilitate the development of robust and reliable machine learning models.

### Feature Engineering Control Platform Architecture

This section of the disclosure provides a description of improved systems and methods that simplify the generation and serving of features needed for artificial intelligence and machine learning. A feature engineering control platform is described herein that can enable individuals (referred to herein as “users”) responsible for developing and managing artificial intelligence models to transform source data, declare features, and run experiments to analyze and evaluate declared features and train artificial intelligence models. Based on experimentation, the feature engineering control platform can enable deployment of feature lists without generating separate feature pipelines or using alternative tools. Complexity associated with such deployment can be abstracted away from users and features can be automatically materialized into an online and/or offline feature store included in the feature engineering control platform. Features included in the online feature store may be made available for serving to artificial intelligence models and related systems with low latency (e.g., via an application programming interface (API) service such as a representational state transfer (REST) API service).

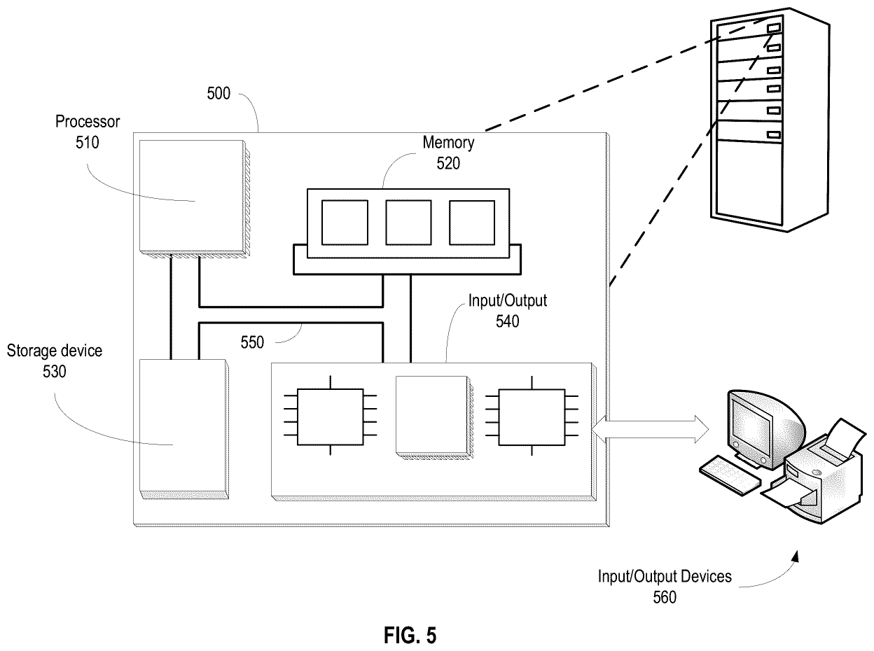

In some embodiments, to remedy several of the deficiencies of existing techniques for feature engineering for artificial intelligence models as described herein, a feature engineering control platform may be introduced. A feature engineering control platform may operate at a computing system including one or more computing devices (e.g., as described with respect to FIG. 5) communicatively connected by one or more computing networks. In some cases, the feature engineering control platform may operate and be stored in a cloud computing system (also referred to as a “cloud data platform”) provided by a cloud computing provider. The cloud computing system may be associated with and/or otherwise store data corresponding to a client. In some cases, the client associated with the cloud computing system may be the cloud computing provider. In some cases, the client associated with the cloud computing platform may be different from a platform provider that provides the feature engineering control platform for use by the client. The feature engineering control platform may integrate with a client's data warehouse stored in the cloud computing platform and may receive metadata associated with source data stored and/or received by the client's data warehouse.

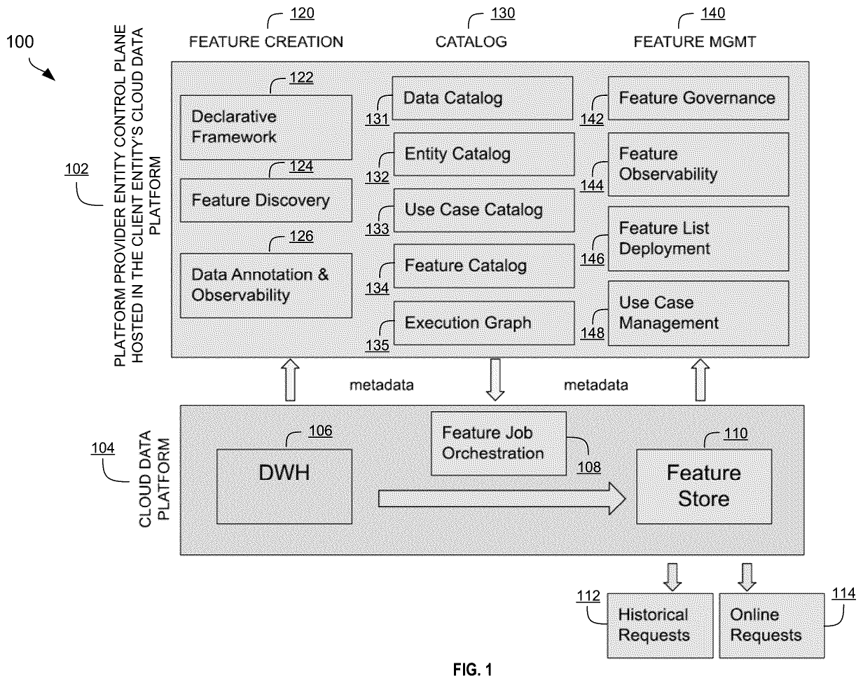

In some embodiments, the feature engineering control platform may be used to automatically and/or manually (e.g., via user input) perform operations for feature creation, feature cataloging, feature management, feature job orchestration, and feature serving relating to training and production operation of artificial intelligence (e.g., machine-learning) models. FIG. 1 is a block diagram of an exemplary feature engineering control platform 100, in accordance with some embodiments as discussed herein. As shown in FIG. 1, feature engineering control platform 100 may operate on one or more computing devices of a cloud data platform 104 (e.g., a cloud data platform corresponding to a client). Feature engineering control platform 100 may also include a platform provider control plane 102 that includes a number of modules. In some cases, cloud data platform 104 may include one or more modules corresponding to the platform provider that are external to platform provider control plane 102. In some cases, feature engineering control platform 100 may include a data warehouse 106 for storage and reception of tables from a number of data sources as described below. Data warehouse 106 may be managed and/or otherwise controlled by the client and may be stored in cloud data platform 104.

In some embodiments, the platform provider control plane 102 may include modules corresponding to feature creation (illustrated as “Feature Creation 120” in FIG. 1), feature cataloging (referred to as “Catalog 130” in FIG. 1), and feature management (referred to as “Feature Mgmt 140” in FIG. 1). Modules corresponding to feature creation 120 may include data annotation and observability module 126, declarative framework module 122, and/or feature discovery module 124. Modules corresponding to catalog 130 may include data catalog module 131, entity catalog module 132, use case catalog module 133, and feature catalog module 134. Catalog 130 can also include an execution graph module 135. Modules corresponding to feature management 140 may include feature governance module 142, feature observability module 144, feature list deployment module 146, and use case management module 148. Additional features of the above-described modules are described herein.

In some embodiments, one or more modules corresponding to the platform provider that are included in the feature engineering control platform 100 may be external to platform provider control plane 102. Examples of such external modules can include modules relating to feature serving such as feature job orchestration module 108 and feature store module 110 stored and operating in a client's data warehouse 106. Additional aspects of the feature job orchestration and feature store modules are described herein. In some cases, metadata may be exchanged between the modules included in platform provider control plane 102 and any of the modules stored in and executing on cloud data platform 104. In some cases, feature store 110 may respond to received historical requests 112 and/or online requests 114 for feature data. The historical and/or online requests may be sent by external artificial intelligence models and related computing systems that are communicatively connected to feature engineering control platform 100. Feature store 110 may provide feature values in response to historical requests 112 and/or online requests 114 for training of artificial intelligence models and/or for production operation of artificial intelligence models. Production operation of an artificial intelligence model can refer to the artificial intelligence model generating output data (e.g., predictions, inferences, and/or content) based on feature values served to the model.

In some embodiments, feature engineering control platform 100 may include a graphical user interface that is accessed by a client computing device via a network (e.g., internet network). The graphical user interface may be displayed and/or otherwise made available via an output device (e.g., display) of the client computing device. A user may provide inputs to the graphical user interface via input device(s) included in and/or connected to the client computing device. The graphical user interface may enable viewing and interaction with feature data and data associated with the modules of the feature engineering control platform as described herein.

In some embodiments, the feature engineering control platform may include a software development kit (SDK) that is used by a client computing device to access and interact with the feature engineering control platform via a network (e.g., internet network). Execution of software (e.g., computer-readable code) using the SDK may enable interaction with feature data and data associated with the modules of the feature engineering control platform as described herein.

### Feature Creation

In some embodiments, modules of a feature engineering control platform corresponding to feature creation may include data annotation and observability, declarative framework, and/or feature discovery modules. The data annotation and observability module of the platform provider control plane may perform functions relating to registration of source data (e.g., source tables), annotation of data types, entity tagging, data semantics tagging, data cleaning, exploratory data analysis, and data monitoring for source data (e.g., tables) registered with the feature engineering control platform and stored in the data warehouse. The data warehouse may ingest and store source data (e.g., tables) of one or more types. Some non-limiting examples of types of source data (e.g., tables) that may be recognized and used by the feature engineering control platform to generate features may include event tables including event data, item tables including item data, slowly changing dimension tables including slowly changing dimension data, dimension tables including dimension data, and time-series tables including time-series data. Additional non-limiting examples of types of source data (e.g., tables) that may be recognized and used by the feature engineering control platform to generate features may include sensor tables and calendar tables. A type of an instance of source data (e.g., table) may determine the transformations that may be applied to the source data (e.g., table) as described herein. In some cases, each of the types of source data used by the feature engineering control platform may have a tabular format.

In some cases, source data (e.g., tables) may reside in external computing systems, such as external cloud computing platforms (e.g., platforms provided by Snowflake and/or Databricks). The data warehouse may ingest source data (e.g., tables) from connected data sources. In some cases, source data (e.g., tables) may include comma separated value (csv) and/or parquet snapshots that can be used to run modeling experiments, such as feature list tuning.

“Event data” may refer to data representative of one or more discrete events (e.g., business events), each measured at a respective point-in-time. In some embodiments, event data are organized or encoded in a tabular format (e.g., as an event table, or as one or more rows of an event table). In some embodiments, an event table (also referred to as a “transaction fact table”) may be a data table including a number of rows, where each row is representative of a discrete event (e.g., business event) measured at a point-in-time. Each row may include one or more column values indicative of information for the event. In some embodiments, each row of an event table includes and/or is otherwise associated with a respective timestamp. As an example, the respective timestamp for an event corresponding to a row of an event table may be a timestamp at which the event occurred. The timestamp may be a Coordinated Universal Time (UTC) time. The timestamp can include a time zone offset to allow the extraction of date parts in local time. When the specified timestamp is not a timestamp with a time zone offset, a user may specify the time zone. Examples of the time zone of the data may be a single value for all data included in the event data or a column included in the event table. Some non-limiting examples of event tables include an order table in e-commerce, credit card transactions in banking, doctor visits in healthcare, and clickstream on the internet. Some non-limiting examples of common features that may be extracted from an event table can include recency, frequency and monetary metrics such as time since customer's last order, count of customer orders in the past 4 weeks and sum of customer order amounts in the past 4 weeks. Features can include timing metrics such as count of customer visits per weekday the past 12 weeks, most common weekday in customer visits the past 12 weeks, weekdays entropy of the past 12 weeks customer visits and clumpiness (e.g., overall variability) of the past 12 weeks customer visits. Features can include stability metrics such as weekdays similarity of the past week customer visits with the past 12 weeks visits. Some non-limiting examples of features that may be extracted for the event entity of the event table (e.g., an order) can include an order amount, an order amount divided by customer amount averaged over the 12 past weeks, and order amount z-score based on the past 12 weeks' customer order history.

“Item data” may refer to data representative of one or more attributes of one or more events. In some embodiments, item data are organized or encoded in a tabular format (e.g., as an item table, or as one or more rows of an item table). In some embodiments, an item table may be a data table including a number of rows, where each row is representative of at least one attribute (e.g., detail) of a discrete event (e.g., business event) measured at a point-in-time. An item table may have a “one to many” relationship with an event table, such that many items identified by an item table may correspond to a single event included in an event table. An item table may not explicitly include a timestamp. In this case, the item table is implicitly related to (e.g., associated with) a timestamp included in an event table based on the item table's relationship with the event table. Some non-limiting examples of item tables can include product items purchased in customer orders and drug prescriptions of patients' doctor visits. Some non-limiting examples of common features that may be extracted from an item table can include amount spent by customer per product type in the past 4 weeks, customer entropy of amount spent per product type over the past 4 weeks, similarity of customer's past week's basket with their past 12 weeks' basket, similarity of customer's basket with customers living in the same state for the past 4 weeks.

In some embodiments, time-series data are organized or encoded in a tabular format (e.g., as a time-series table, or as one or more rows of a time-series table). In some embodiments, a time-series table may be a data table including data collected at discrete, successive, regularly spaced (e.g., equally spaced) points in time. In some cases, rows in a time-series data table may represent an aggregated measure over the time unit (e.g., daily sales) or balances at the end of a time period. In some cases, records may be missing from a time-series data table and the time unit (e.g., hour, day, month, year) of the time-series data table may be assumed to be constant over time. In some cases, the time-series table is a multi-series where each series is identified by a time series identifier. Some non-limiting examples of common features for time-series table are aggregates over time such as shop sales over the past 4 weeks. Seasonal features are also common for time-series table. Examples of seasonal features can include the average sale for the same day over the 4 weeks, where the day is derived by the date of the forecast in the feature request data.

“Slowly changing dimension data” may refer to relatively static data (e.g., data that change slowly (e.g., infrequently), data that change slowly and unpredictably, etc.). In some embodiments, slowly changing dimension data are organized or encoded in a tabular format (e.g., as a slowly changing dimension table, or as one or more rows of a slowly changing dimension table). In some embodiments, a slowly changing dimension table may be a data table that includes relatively static data. A slowly changing dimension table may track historical data by creating multiple records for a particular natural key. Each natural key (also referred to as an “alternate key”) instance of a slowly changing dimension table may have at most one active row at a particular point-in-time. A slowly changing dimension table can be used directly to derive an active status, a count at a given point-in-time, and/or a time-weighted average of balances over a time period. A slowly changing dimension table can be joined to event tables, time-series tables, and/or item tables. A slowly changing dimension table can be transformed to derive features describing recent changes indicated by the table. Some non-limiting examples of common features that may be extracted from views based on a slowly changing dimension table corresponding to a 6 month period for a customer may include a number of times a customer has moved residences, previous locations of residences where a customer lived, distances between the present residence and each of the previous residences, an indication of whether the customer has a new job, and a time-weighted average of the balance of the customer's bank account.

“Dimension data” may refer to descriptive data (e.g., data that describe an entity). In some embodiments, dimension data are static. In some embodiments, dimension data are organized or encoded in a tabular format (e.g., as a dimension table, or as one or more rows of a dimension table). In some embodiments, a dimension table may be a data table that includes one or more rows of descriptive data (e.g., static descriptive information, such as a date of birth). A dimension table may correspond to a particular entity, where the entity is the primary key of the dimension table. A dimension table can be used to directly derive features for an entity (e.g., an individual, a business, a location, etc.) that is a primary key of the dimension table. In some cases, a dimension table may be joined to an event table and/or an item table. In some cases, new rows may be added to a dimension table. Based on the addition of new rows to a dimension table, no aggregation may be applied to a dimension table as the addition of new records can lead to training and serving inconsistencies.

In some embodiments, a user may register a new data source (e.g., source table) with the feature engineering control platform via the data annotation and observability module. For example, a user may connect an external cloud data source with the feature engineering control platform. Source data (e.g., tables) provided from data sources connected to the feature engineering control platform may be received and stored by the data warehouse. When the user connects and registers a new data source, the user may tag the new table(s) provided from the new data source. The user may tag the new table(s) as corresponding to a particular data type described herein. In some cases, different data provided by a particular data source may correspond to different data types. As an example, a user may tag the primary key for a dimension table; the natural key for slowly changing dimension table, the slowly changing dimension table's effective timestamp, and optionally the slowly changing dimension table's active flag, and the end timestamp of a row's activity period; the event key and timestamp for an event table; the item key, the event key, and the event table associated with an item table; the sensor key and timestamp for sensor table; and the time series identifier for the multi time-series table, its date or timestamp, and its corresponding time unit and format.

In some embodiments, the feature engineering control platform may prompt the user to provide the above-described tags. In some cases, during registration of time-series table from a new data source, a user may annotate the time unit and format of the time-series data date or timestamp. Some examples of supported time units for time-series data (e.g., a time-series table) may include multiples of one minute, one hour, one day, one week, one month, one quarter, and one year units. Some examples of supported date-times may be a year, year-quarter, year-month, date, and timestamp with a time zone offset. When a time unit for time-series data is a week, date-time may be the first day of the week. When a time unit for time-series data is less than or equal to one hour, the date-time may be a timestamp with a time zone offset. When a time unit for time-series data is less than or equal to one hour, the timestamp may be assumed to indicate the beginning of the time period and may be changed by a user. When the specified date-time format for time-series data is not a timestamp with a time zone offset, a user may specify the time zone of the date. Examples of the time zone of the data may be a single value for all data included in the time-series table or a column included in the time-series table.

In some embodiments, time-series data (e.g., a time-series table) may be derived from event data (e.g., an event table). A time-series table can be derived from an event table based on a selection of an entity, a column, an aggregation function, and a time unit from the event table. Based on the selection, a time-series table may be generated and metadata for the time-series table may be automatically inferred.

In some cases, during registration of an event table from a new data source (e.g., source table), a user may annotate a record creation timestamp for the event data included in the event table. In some embodiments, the feature engineering control platform may prompt the user to provide such annotation. Annotation of a record creation timestamp may automatically cause analysis of event data availability and freshness. Analysis of the event data availability and freshness may enable automated recommendation of settings for feature job scheduling by the feature job orchestration module. Recommendation of a default setting for feature job scheduling may abstract the complexity of setting feature jobs of features extracted from the event table. Additional features of automatic feature job scheduling are described herein at least in the section titled “Exemplary Techniques for Automated Feature Job Setting.”

In some embodiments, with respect to data semantics, the data annotation and observability module may enable identification of semantics of data fields included in the received source data (e.g., data fields of tables). Each data source registered with the feature engineering control platform may include or be associated with a semantic layer that captures and accumulates the domain knowledge acquired by users interacting with the same source data. In the semantic layer, semantics for data fields included in received source data may be encoded based on a data ontology configured to enable improved feature engineering capabilities. The ontology and semantics described herein may characterize data fields of source data received from each data source. Data fields of source data (e.g., columns of tabular data) may be characterized to correspond to one or more of the levels (e.g., all applicable levels) for the hierarchical tree-structure of the ontology described herein.

In some embodiments, during and/or after registration of a table, a user may tag the table provided from the data source. The user may tag individual data fields (e.g., columns) and/or groups of data fields of the table with respective semantic types of a data ontology as described herein. In some cases, the feature engineering control platform may prompt the user to provide the data ontologies for data fields of the table. Data ontologies for data fields of the table may be provided via a graphical user interface and/or an SDK of the feature engineering control platform.

### First Example of a Data Ontology

In some embodiments, with respect to data ontology, an ontology (or taxonomy) applied to data fields of a table by the data annotation and observability module may have a hierarchical tree-based structure, where each node included in the hierarchical tree-structure represents a particular semantics type corresponding to specific feature engineering practices. The tree-structure may have an inheritance property, where a child node inherits from the attributes of the parent node to which the child node is connected. The tree-structure may include a number of levels. Nodes of a first level of the tree-structure may represent basic generic semantics types associated with incompatible feature engineering practices and may include a numeric type; a binary type; a categorical type; a date-time type; a text type; a dictionary type; and a unique identifier type.

In some cases, nodes of second and third levels of the tree structure may represent more precise generic semantics for which additional feature engineering is commonly used. Nodes of a fourth level of the tree structure may be domain-specific.

In some embodiments, for the numeric type, the nodes of the second level connected to the numeric type may determine whether particular operations may be applied to the data field of the table characterized with the numeric type to generate features. Examples of the operations can include whether a sum can be used, average can be used, a weighting can be used, and/or circular statistics should be used on the data field characterized with a numeric type. Nodes of the second level that are connected to the numeric type may include additive numeric type nodes, semi-additive numeric type nodes, non-additive numeric type nodes, ratio/percentage/mean type nodes, ratio numerator/ratio denominator type nodes, and/or circular type nodes. For an additive numeric type node, sum aggregation operations may be recommended, in addition to mean, maximum, minimum, and standard deviation operations. An example of an additive numeric type of data field is a field indicating customer payments for purchases. For a semi-additive numeric type node, sum aggregation operations may be recommended at a point-in-time (e.g., only at a point-in-time). Examples of semi-additive numeric types of data field include an account balance or a product inventory. For a non-additive numeric type node, mean, maximum, minimum, and standard deviation operations may be commonly used, but a sum operation may be excluded. An example of a non-additive numeric type of data field is a field indicating customers' ages. For a ratio/percentage/mean type node, weighted average and standard deviation operations may be recommended, and unweighted maximum and minimum operations may be recommended. A sum operation may be excluded for this type. For a ratio numerator/ratio denominator type node, a ratio may be derived, two or more sum aggregations may be derived, and the ratios of any two of the sums may be recommended. An example of a ratio numerator/ratio denominator type of data field is moving distance and moving time, where the ratio is a speed at a given time from which a maximum speed can be extracted, the sums are travel distance and travel duration, and the ratio of the sums is the average speed. For a circular type node, circular statistics may be recommended. Examples of data fields of a circular type can include a time of a day, a day of a year, and a direction.

In some embodiments, for the non-additive numeric type, the nodes of the third level connected to the non-additive numeric type may include a measurement-of-intensity node, an inter-event time node, a stationary position node, and/or a non-stationary position node. A measurement of intensity node may indicate the intensity or other value of a measurable quantity (e.g., temperature, sound frequency, item price, etc.). For a measurement of intensity node, change from a prior value may be derived. For an inter-event time node, clumpiness (e.g., a variability of event timings) may be applied. A stationary position node may represent the position (e.g., geographical position) of a stationary object (e.g., using latitude/longitude coordinates or any coordinates of any other suitable coordinate system). For a stationary position node, distance from another location (e.g., another location node) may be derived. A stationary position node may represent the position of a non-stationary object (e.g., an object that is moving, is permitted to move, or is capable of moving). For a non-stationary position node, moving distance, moving time, speed, acceleration, and/or direction may be derived.

In some embodiments, for the additive numeric type, the nodes of the third level connected to the additive numeric type may include a positive amount node. For a positive amount node, statistical calculations grouped per the category of a categorical column may be applied, or periodic (e.g., daily, weekly, monthly) time-series may be derived.

In some embodiments, examples of domain-specific nodes of the fourth level of the tree-structure can include patient temperature nodes, patient blood pressure nodes, and/or car location nodes. For a patient temperature node, categorization operations may be applied to derive temperature categories (e.g., low, normal, elevated, fever, etc.). For a patient blood pressure node, categorization operations may be applied to derive blood pressure categories (e.g., hypotension, normal, hypertension, etc.). For a car location node, a highway on which the car is located may be detected, and categorization operations may be applied to derive movement categories (e.g., high acceleration, low acceleration, high deceleration, low deceleration, high speed, low speed, etc.).

In some embodiments, for the categorical type, the nodes of the second level connected to the categorical type may indicate whether the categorical field is an ordinal type. Examples of features extracted from categorical fields can include a count per category, most frequent, unique count, entropy, similarity features, and/or stability features. In some cases, nodes of the third level connected to the categorical type can indicate whether the categorical field is an event type. When the categorical field is an event type, operations that may be applied to the corresponding event data (e.g., event table) can include identifying the event type for each row of the event table, and generating one or more features by performing operations on rows having the same event type.

In some embodiments, domain specific nodes of the fourth level can indicate further feature engineering and related best practice operations that may be applied to the source data (e.g., table). For example, for a zip code, a best practice may include concatenating the zip code with a data field having a country semantics type. For a city, a best practice may include concatenating the city with a data field having state and country semantics types. For an ICD-10-CM, a best practice may include extracting the first three symbols of ICD-10-CM.

In some embodiments, for the date-time type (e.g., a timestamp), operations applied to the data field corresponding to the date-time type may include extracting date parts such as a year, month of a year, day of a month, day of a week, hour of a day, time of a day, and/or day of a year. The nodes of the second level connected to the data-time type may indicate whether the timestamp is an event timestamp type, a start date, or an end date. The nodes of the third level connected to the event timestamp type may indicate whether the event timestamp type is a measurement event timestamp or a business event timestamp. A measurement event timestamp may be the timestamp of measurement that occurs at predictable (e.g., periodic or threshold) intervals (e.g., in sensor data). A business event timestamp may be the timestamp of a discrete business event measured at a point-in-time. Examples of business event timestamps can include order timestamps in e-commerce, credit card transactions timestamp in banking, doctor visits timestamps in healthcare, and click timestamps on the internet. For a business event timestamp, examples of extracted features can include a recency with time since a last event, the clumpiness of events (e.g., variability of inter-event time), an indication of how a customer's behavior compares with other customers, and/or indications of changes in the customer's behavior over time.

### Second Example of a Data Ontology

In some examples, a data ontology applied to data fields of a table by the data annotation and observability module may have a hierarchical tree-based structure, where each node included in the hierarchical tree-structure represents a particular semantics type corresponding to specific feature engineering practices. The tree-structure may have an inheritance property, where a child node inherits from the attributes of the parent node to which the child node is connected. The tree-structure may include a number of levels. Nodes at a first level of the tree-structure may represent basic and/or generic semantic types associated with incompatible feature engineering practices and may include a numeric type; a binary type; a categorical type; a date-time type; a text type; a dictionary type; and a unique identifier type.

In some cases, nodes of an intermediate level (e.g., levels 2 and 3) of the tree structure may represent more precise generic semantics for which advanced feature engineering is commonly used. Nodes of a fourth level of the tree structure may be domain-specific. Some first level nodes may connect to one or more level 2 nodes, which in turn may connect to level 3 nodes, which themselves may connect to level 4 nodes. Nodes may or may not include connections to nodes of more specific types. For example, a level 1 node may connect to several level 2 nodes that themselves do not connect to level 3 nodes. As an additional example, a level 1 node may connect to several level 2 nodes, some of which connect to level 3 nodes. Some of those level 3 nodes in turn may connect to level 4 nodes. Of note, root or first level node types are alone often not precise enough to guide the feature engineering principles described herein. Thus, a data ontology can include child nodes that inherit the properties of their parent nodes, and these child nodes can be used to guide feature engineering more precisely.

Nodes at the first level of the tree-structure can include a variety of type identifiers and/or be of a variety of types. For example, a level 1 node can have a “unique identifier type” that includes a unique identifier that uniquely identifies the table record, such as user IDs, serial numbers, and the like. Unique identifier nodes can connect to level 2 nodes that are identified during the table registration process, such as “event ID,” “item ID,” “dimension ID,” “surrogate key,” “natural key,” and/or “foreign key” types.

Level 1 nodes can also be of an “numeric” type which includes numeric data with values applicable for statistic operations such as mean and standard deviation. Integers used as category labels are generally excluded from this type. Level 2 nodes associated with numeric types can determine whether summation and/or circular statistics functions can be applied to the data. In one example, level 2 subtypes of numeric types can include “non-additive numeric” types for which mean, max, min, and/or standard deviation statistical functions are commonly used, but summation functions are not. As a specific example, non-additive numeric types can be customer ages. Non-additive numeric types can connect to level 3 subtypes or nodes, such as a “measurement of intensity” type (e.g., temperature, sound frequency, item price, etc.) for which a change from a prior value can be derived. Some examples of level 4 nodes connected to measurements of intensity include “patient temperature” which can be categorized into ranges such as low, normal, and fever. Additional examples include “patient blood pressure” for which range categorizations such as hypotension, normal, and hypertension can be derived.

Level 2 numeric type nodes also include “semi-additive numeric” types for which sum aggregation is recommended only at specific points in time, such as for account balances or product inventories.

Some level 2 numeric type nodes can be of an “additive numeric type”, in which case sum aggregation is recommended in addition to mean, max, min, and/or standard deviation statistical functions. For example, an additive numeric type can be customer payments for purchases. Additive numeric types can connect to level 3 nodes such as “non-negative amount” types for which statistics grouped by categorical columns can be applied.

In some embodiments, numeric type nodes can connect to “inter-event distance types”, for which sum aggregation can be done (differentiated from common distances which may be categorized as non-additive numeric nodes).

In further examples, numeric type nodes can connect to “inter-event time nodes.” These data types are suitable for applying distribution metrics to measure behavior, such as marathon-watching patterns for users of streaming services. These nodes can in turn connect to level 3 nodes such as “inter-event moving time,” which can help determine whether using sum aggregation on the data is likely to yield meaningful insights.

In some examples, ambiguous number type nodes can connect to “circular type” nodes which represent data for which circular statistics are usually needed. For example, circular type data can include a time of day, a day of a year, and/or a direction.

In some examples, a first level node can be of a “binary” type that has data of one of two distinct values (e.g., 0 or 1).

In some embodiments, a first level node can be of a “categorical type,” which includes data with a finite set of categories represented as integers or strings. In these embodiments, level 2 nodes of the categorical type can include an “ordinal” type. Operations such as minimum, median, maximum, and/or mode calculations can be applied to features of this type and other features commonly extracted from categorical features. Level 3 categorical type nodes can identify whether a particular feature is an “event status” or an “event type” feature. In these cases, data can be divided into subsets for each particular event type or event status.

In some embodiments, first level nodes can have an “ambiguous categorical” type, which includes data with unclear or overlapping definitions. For example, an ambiguous categorical type can include city names that are not accompanied by state or country information, resulting in difficulty determining the exact city being referenced due to the existence of multiple cities with identical names in different regions. Additionally or alternatively, an ambiguous categorical type can be used for categorical records entered in non-standardized formats.

In some embodiments, a first level node can be of a “text” type, which includes textual data that can be used for complex processing applications such as natural language processing. Level 2 nodes of the text type can include “special text” nodes, which can be subdivided into level 3 nodes such as “street address,” “URL,” “email,” “name,” “phone number,” and/or “software code” types. Other level 2 text-type nodes include “long text” nodes, which can connect to level 3 nodes such as “review,” “twitter post,” “resume,” or “description” types. Other level 2 text types can also include “numeric-with-unit” types.

In some examples, a node can have a “date/time” type that includes data representing dates and times. These nodes may require additional semantic processing to determine the exact date or time being referenced. Level 2 nodes connected to date/time types can help determine whether a field is a special field related to a table type or a different kind of data. Table-specific date/time level 2 node types include “event timestamp,” “record creation timestamp,” “effective timestamp,” “end timestamp,” “sensor timestamp,” “time series timestamp,” and “time series date.” Other examples include “timestamp field,” “date field,” and “year.” Level 3 nodes associated with the date/time type include “date of birth,” which is important to derive age and other age-related features. Other level 3 nodes include “start date” which can be used to create recency features, and “termination date” which can be used to divide data to create count features as a point in time.

In some embodiments, a node can have a “coordinates” type, indicating a particular location or position using a coordinate mapping. For example, a coordinate type node can include geographic data such as latitude and/or longitude values. Level 2 coordinate-type nodes include “local longitude” and “local latitude” types. These types can be subjected to approximation or other simple mathematical operations (e.g., statistical mean). Level 3 coordinate-type nodes can identify whether the coordinates correspond to the coordinates of a moving object. Features with moving object types can be transformed into statistics on object speed or other movement-related measurements.

In some cases, a first level node can be of a “unit” type, representing data indicating units of measurement.

In further embodiments, a node can have a “converter” type, representing data that is used to convert of map between different units or types. For example, a converter type can include conversion rates between currencies.

In some examples, a node can have a “list” type, representing data that is presented in a list format and containing multiple items.

In some embodiments, a node can represent a “dictionary” type, representing data stored in a key-and-value pair format.

In further examples, a node can include a “sequence” type, representing an ordered list of elements.

In some examples, a node can include a “non-informative” type. Non-informative types can represent data with minimal analytical value and can also be used to indicate data that should not be used for feature engineering.

In some embodiments of the above-described ontologies, for the text type, the nodes of the second level connected to the text type may indicate whether the text field is a special text type or a long text type. The nodes of the third level connected to the special text type can include node types for address, uniform resource locator (URL), email address, name, phone number, software code, and/or position (e.g., latitude and longitude). The nodes of the third level connected to the long text type can include node types for review, social media message, diagnosis, and product descriptions.

In some embodiments, for the dictionary type, the nodes of the second level connected to the dictionary type may indicate whether the dictionary field is a dictionary of non-positive values, dictionary of non-negative values, or dictionary of unbounded values. The nodes of the third level connected to the dictionary non-negative values type can include node types for bag of sequence n-grams, dictionary of items count, and/or dictionary of items positive amount. The nodes of the fourth level for the dictionary type can include node types for bag of words n-grams, bag of click type n-gram, bag of diagnoses code n-grams, dictionary of product category count, and/or dictionary of product category positive amount. As used herein, in the context of natural language processing (NLP), “N-gram” may refer to a contiguous sequence of N items from a text or speech sample. For purposes of text analysis, these items can be words, letters, or symbols (e.g., characters). The value of N determines the length of the sequences, with bigrams (2-grams), trigrams (3-grams), etc., representing sequences of 2 items, 3 items, and so on. As used herein, “sequence N-gram” is a generalization of the N-gram concept from NLP. Instead of limiting the items to words, letters, or symbols, sequence N-grams can include other types of sequential events or items. Sequence N-grams can be applied in various domains, where analyzing the sequence of events can reveal patterns or trends. As used herein, a “click type N-gram”is a specific type of N-gram used for user interaction analysis. A click type N-gram may include a sequence of click-based user-interface actions (e.g., ‘add to cart,’ ‘remove item,’ ‘navigate to page,’ etc.) initiated by a user via a user interface. Click type N-grams can be especially useful in understanding user behavior on websites or applications. As used herein, “diagnosis code N-gram” refers to a sequence of medical diagnoses codes. Any suitable type of medical diagnose code can be used (e.g., the codes specified in the ICD-10 classification). In healthcare data analysis, diagnosis code N-grams can be used to analyze and characterize patterns in disease progression, comorbidities, or treatment sequences.

In some embodiments, views may inherit and/or otherwise include the data ontology of source data (e.g., tables) used to generate the views. As described herein, data fields (e.g., columns) of source data (e.g., tables) may be tagged with annotations of data types corresponding to a data ontology. When source data are transformed and/or otherwise manipulated to generate a view, the view may include the data ontology of the data fields of the source data used to generate the view. In some cases, a view may inherit and/or otherwise include the data ontology of other view(s) that have been joined to the view. Data fields (e.g., columns) included in a view that are derived by one or more transformations may include a data ontology that is based on the type of transformation(s) used to generate the data field. The data annotation and observability module may automatically assign a data ontology to new data fields included in views that are derived from one or more transformations based on the data ontology of data fields used to generate the new data fields.

In some embodiments, similar to tagging of semantic types of data fields of source data (e.g., tables) in accordance with a data ontology, a user may tag data fields of a view. The user may tag data fields (e.g., columns) of a view with respective semantic types as described herein. In some cases, a user may override an existing tag indicating a semantic type for a data field of a view. In some embodiments, the feature engineering control platform may prompt the user to provide the semantic types for data fields of views that lack existing annotations of semantic types. Semantic types for data fields of views may be provided via a graphical user interface and/or an SDK of the feature engineering control platform.

In some cases, the data annotation and observability module may enable tagging of entities to a set of source data (e.g., a table) to establish connections between the entities and the source data. As described herein, an entity may be a logical or physical identifiable object of interest. To establish a connection between an entity and the source data, a user may tag fields (e.g., columns) of the source data (e.g., table) that are representative of the entity in the connected data sources (e.g., source tables). Columns tagged for a given entity may have different names (e.g., custID and customerID both referring to a customer identifier) and an entity may have one unique serving name (also referred to as a “serving key”) used for feature requests (e.g., received from an external artificial intelligence model). In some cases, when no feature is associated with an entity, tagging of tables corresponding to an entity may be encouraged based on the tagging aiding in recommendation of joins and features. When no feature is associated with an entity, a column tagged for the entity can typically be a primary (or natural) key of a data table received from a data source.

In some embodiments, the data annotation and observability module may automatically establish child-parent relationships between entities. Child-parent relationships may be used to simplify feature serving, to recommend features from parent entities for a use case, and/or to suggest similarity features that compare the child and parent entities of a child-parent relationship. In some cases, an entity may be automatically set as the child entity of other parent entities when the entity's primary key (or natural key) references a data table in which columns are tagged as corresponding (e.g., belonging) to other entities. In some cases, users may establish subtype-supertype relationships between entities. An entity subtype may inherit attributes and relationships of the entity supertype. As examples of subtype-supertype relationships, a city entity type may be the supertype of a customer's city, merchant's city, and destination's city entity type and people entity type may be a supertype of a customer and an employee entity type.

In some embodiments, an entity may be associated with a feature. An entity associated with a feature defined by an aggregate may be the entity tagged to the aggregate's GroupBy key. When more than one key is used in GroupBy, a tuple of entities can be associated with a feature. In some cases, when a feature is defined via a column of a data table or a view, the feature's entity is the table's primary key (or natural key). When a feature is derived from multiple features, the entity of the respective feature may be the lowest-level child entity.

In some embodiments, an entity related to business events (e.g., complaints or transactions) may be referred to as an “event entity” in the feature engineering control platform. For use cases that are related to an event entity, features may be served using windows of time that exclude the event of the request. For example, for a use case of a transaction fraud detection, a windowed aggregation implementation of the feature engineering control platform may ensure the feature windows of time exclude the current transaction and avoid leaks when comparing the current transaction to previous transactions.

In some embodiments, a feature can be served by providing the serving name of the feature entity and the instances of the entity desired. In some embodiments, for a historical feature request, the points-in-time of each instance are provided in the historical feature request. The points-in-time may not be provided for an online feature request based on a point-in-time of an online feature request being equal to the time of the online feature request. When the entity is an event entity, at least some information relevant to serving a feature online may not have been received and recorded in the data warehouse at inference time for an artificial intelligence model. At least some information relevant to serving a feature may not have been received and recorded in the data warehouse based on the data warehouse not receiving source data in real-time. In this case, the feature engineering control platform may prompt the user to provide the missing information as part of the online feature request. When the feature entity has one or more child entities, the feature can also be served via any of the one or more child entities. The serving name of the child entity and its entity instances may be provided in place of the serving name of the feature entity and its entity instances.

In some embodiments, with respect to data cleaning, the data annotation and observability module may enable cleaning of data received from connected data sources (e.g., source tables). In some cases, users may annotate and tag received data to indicate a quality of the source data at a table level. In some cases, users may declare one or more data cleaning steps performed by the data annotation and observability module for received source data. In some cases, declaration of data cleaning steps can include declaring how the data annotation and observability module can clean source data including: missing values, disguised values, values not in an expected list, out of boundaries numeric values and/or dates, and/or string values received when numeric values or dates are expected. In some cases, users can define data pipeline data cleaning settings to ignore values with quality issues when aggregations are performed or impute the values with quality issues. If no data cleaning steps are explicitly specified by a user, the data annotation and observability module may automatically enforce imputation of data values with quality issues.

In some embodiments, a declarative framework module of the platform provider control plane may perform functions relating to definition of features and targets (e.g., including definition of temporal parameters for features and targets) and specification of data transformations performed on source data (e.g., tables), features, and targets.

In some embodiments, the declarative framework module may enable generation of views based on application of one or more data transformations to source data (e.g., tables). With respect to views that can be generated based on data transformations applied to source data (e.g., tables) via the declarative framework module, the data transformations may be translated by the execution graph module as a graphical representation of intended operations referred to as an “execution graph,” “query graph,” and “execution query graph.” The execution graph may be converted into platform-specific SQL (e.g., SnowSQL or SparkSQL). The data transformations may be executed when their respective values are needed, such as when a preview or a feature materialization is performed. As described herein, a view may inherit and/or otherwise include the data ontologies of tables and/or other views that are used to generate the view.

In some embodiments, for the feature engineering control platform, transformations can be applied to a view object where cleaning can be specified; new columns can be derived; lags can be extracted; other views can be joined; views can be subsetted; columns can be edited via conditional statements; changes included in a slowly changing dimension table can be converted into a change view; event views can be converted into time-series data; and time-series data can be aggregated.

In some embodiments, views may be automatically cleaned based on the information collected during data annotation (e.g., as described with respect to the data annotation and observability module). Users can override the default cleaning by applying the desired cleaning steps to the source data received from the data source (e.g., source table).

In some embodiments, a number of transforms can be applied to columns included in a view by the declarative framework module. In some cases, a transform may return a new column that can be assigned (e.g., appended) to the view or be used for further transformations. In some cases, some transforms may be available only for certain data types as described herein. In some cases, a generic transform may be available for application to columns of all data types described herein. Examples of generic transforms can include isnull (e.g., get a new boolean column indicating whether each row is missing); notnull (e.g., get a new boolean column indicating whether each row is non-missing); fillna (e.g., fill missing value in-place); and astype (e.g., convert the data type).

In some cases, a numeric transform may be available for application to a numeric column and may return a new column. Examples of numeric transforms can include built-in arithmetic operators (+, −, *, /, etc.); absolute value; square root; power; logarithm with natural base; exponential function; round down to the nearest integer; and round up to the nearest integer.

In some cases, a string transform may be available for application to a string column and may return a new column. Examples of string transforms can include get the length of the string; convert all characters to lowercase; convert all characters to uppercase; trim white space(s) or a specific character on the left & right string boundaries; trim white space(s) or a specific character on the left string boundaries; trim white space(s) or a specific character on the right string boundaries; replace substring with a new string; pad string up to the specified width size; get a Boolean flag column indicating whether each string element contains a target string; and slice substrings for each string element.

In some cases, a date-time transform may be available for application to a date-time column. Examples of date-time transforms can include calculate the difference between two date-time columns; date-time component extraction (e.g., extract the year, quarter, month, week, day, day of week, hour, minute, or second associated with a date-time value); and perform addition with a time interval to produce a new date-time column.

When date-time transforms are applied to a timestamp with a time zone offset, date parts (e.g., day of week, month of year, hour of day) can be extracted based on the local time zone. In some cases, for a given entity corresponding to a table, lags can extract a value of a previous row for the same entity instance as a current row. Lags may enable computation of features that are based on inter-event time and distance from a previous point. Seasonal lags for the same time-series identifier can be extracted in time-series data (e.g., a time-series table). For example, users may define a 7 day frequency period to generate lag for the same day of a week as the current. Users can also choose to skip the missing records or impute the missing records. In some cases, to facilitate time-aware feature engineering, the event timestamp of the related event data may be automatically added to an item view by a join operation. Other join operations may be recommended for application to a view when an entity indicated by the view (or the entity's supertype) is a primary key or a natural key of another view. In some cases, joins of slowly changing dimension views may be made at the timestamp of the calling view. In some cases, the declarative framework module may enable condition-based subsetting, such that views can be filtered. A condition-based subset may be used to overwrite the values of a column in a view. In some cases, the declarative framework module may enable joins of calendar data (e.g., a calendar table) to times-series views or event views. A join of a calendar table to a time-series table may be backward or forward. A suffix may be added to the added column to indicate a non-null offset.

In some embodiments, cross-time-series identifier aggregation may be performed for a parent entity, which may generate new time-series data (e.g., a new time-series table or view). In some cases, a change to a larger time unit for time-series data (e.g., a time-series table) may be supported. Changing to a larger time unit may create a new view based on a time-series table, where the serving name of the time-series table date-time column may be specified (e.g., by a user via the graphical user interface). Changing to a larger time unit may cause generation of a new feature job setting based on a time zone when the new time unit is a day or larger than a day.

In some embodiments, changes in a slowly changing dimension table can indicate powerful features, such as a number of times a customer moved address in the past 6 months, previous residences of the customer, a change in marital status of the customer, a change in a number of a customer's children, and/or changes to a customer's employment status. To generate such types of features, users can generate a change view from a slowly changing dimension table, where the change view may track changes for a given column of the slowly changing dimension table. Features may be generated from the change view similar to generation of features from an event view. In some cases, the change view may include four columns including a change timestamp (e.g., equal to the effective timestamp of the slowly changing dimension table); the natural key of the slowly changing dimension view; a value of the column before the change; and a value of the column after the change.

In some embodiments, the declarative framework module may enable generation of features. The declarative framework module may cause generation of features from views based on optional data manipulation operations applied to views. In some cases, the declarative framework module may generate lookup features. When an entity is the primary key of a view, a column of the view can be directly converted into a lookup feature for the entity. Some non-limiting examples of lookup features can include a customer's place of birth and a transaction's amount (e.g., dollar amount). When a unit of analysis of a feature is the natural key of a slowly changing dimension view, a column of the view may be directly converted into a lookup feature. In this case, the feature may be materialized based on point-in-time join operations. The value served for the feature may be the row value active as of the point-in-time of the request. Some non-limiting examples of lookup features from a slowly changing dimension view can include a customer's marital status at a point-in-time of a request or at a historical point-in-time that is before the point-in-time of the request.

In some embodiments, date parts of the time-series table date-time column or columns derived from calendar join operations may be converted into lookup features. Other columns of the time-series data may be converted into lookup features when the columns from which the lookup features are derived have been tagged as “known in advance” and the instances of those columns may be provided as part of an online request data. All lookup features in time-series may be associated with an entity tuple that includes the time-series identifier for the time-series table and the serving name of the time-series table date-time column. When a request is received at the feature store module, instances of the time-series table date-time column may be provided in the request data with the time-series identifier. The instances of the time-series table date-time column provided in the request data can typically represent the date of the time-series forecast.

In some embodiments, the declarative framework module may generate aggregate features. When a target entity is not the primary (or natural) key of a view, features (referred to as “aggregate features”) may be defined via aggregates where an entity column is used as the GroupBy key. For a sensor view, a time-series view, an event view, and an item view, the aggregates may be defined by windows (e.g., corresponding to periods of time) that are prior to the points in time of the request for the feature. Windows used in windowed aggregation can be time-based windows and/or count-based. Some non-limiting examples of aggregate features can include a “customer sum” (e.g., a sum of the order amounts of a customer's orders over the most recent 12 weeks, a sum of the order amounts of the customer's most recent 5 orders, etc.). In some cases, windows can be offset backwards to enable and allow for aggregation of any period of time in the past. An example of such feature can include a customer sum of order amounts from a period of 12 weeks ago to 4 weeks ago (e.g., an 8 week period of time). In a time-series view, windowed aggregations may be performed when (e.g., only when) the time-series identifier of time-series view is defined as the GroupBy key and time-based windows may be a multiple of the time unit of the time-series table. In some cases, date parts operations in the aggregates may be enabled in the time-series view to restrict the aggregation to specific time periods during the window. As an example, a feature may be derived for average sales for a particular day of week over a window of the past 8 weeks. Such seasonal features can be associated with an entity tuple that includes the time-series identifier for the time-series table and the serving name of the time-series table date-time column. When a request is received at the feature store module, instances of the time-series table date-time column may be provided in the request data together with the time-series identifier. The instances of the time-series table date-time column provided in the request data usually represent the date of the time series forecast. Supported date parts for aggregate operations using time-series data may include hour of day, hour of week, day of week, month of year, etc.

In some embodiments, for an item view, when a target entity is the event key of the view, simple aggregates can be applied to the item view to generate aggregate features. An example of such a feature is a count of items included in an order. In some cases, for a slowly changing dimension view, aggregate operations used to generate aggregate features can include aggregates as at a point-in-time, time-weighted aggregates over a window (e.g., time period), and aggregates of changes over a window. For a slowly changing dimension view and an entity that is not a natural key of the slowly changing dimension view, an aggregate operation may be applied to records (e.g., rows) of the slowly changing dimension view that are active as at the point-in-time of a request for a feature. An example of such a feature is a number of credit cards held by a customer at the point-in-time of the request. In some cases, users may be able to specify a temporal offset to retrieve a value of a feature as at some point-in-time (e.g., 6 months) prior to the point-in-time of the request. An example of such a feature is a number of credit cards held by a customer 6 months before the point-in-time of the request. For a slowly changing dimension view and an entity that is a natural key of the slowly changing dimension view, the aggregate operation applied to the slowly changing dimension view may be time-weighted. An example of such a feature is a time-weighted average of account balances over the past 4 weeks. To generate features from aggregate operations on changes, users may generate a change view from a slowly changing dimension table. Based on generating the change view, subsequent aggregate operations may be applied to the change view similar to aggregate operations applied to an event view. An example of such a feature is a number of changes of address over the past 2 years.

In some embodiments, the declarative framework module may include and/or otherwise enable use of a number of aggregation functions to generate aggregate features. Some non-limiting examples of supported aggregation functions can include last event, count, na_count, sum, mean, max, min, standard deviation, and sequence functions. In some cases, aggregation operations per category may be defined. As an example, a feature can be defined for a customer as the amount spent by customer per product category the past 4 weeks. In this case, when the feature is materialized for a customer, the declarative framework module may return a dictionary including keys that are the product categories purchased by the customer and respective values that are the sum spent for each product category.

In some embodiments, the declarative framework module may enable transformation of features similar to the transformations for columns of views as described herein. In some cases, additional transforms may be supported to transform features resulting from an aggregation per category, where the feature instance is a dictionary. Examples of such transformations can include most frequent key; number of unique keys; key with the highest value; value for a given key; entropy over the keys; and cosine similarity between two feature dictionaries.

Examples of respective features that may be generated based on the above-described transforms may include most common weekday in customer visits the past 12 weeks; count of unique products purchased by customer the past 4 weeks; list of unique products purchased by customer the past 4 weeks; amount spent by customer in ice cream the past 4 weeks; and weekdays entropy of the past 12 weeks customer visits.

In some embodiments, the declarative framework module may enable generation of a second feature from two or more features. Examples of such features can include similarity of customer past week basket with her past 12 weeks basket, similarity of customer item basket with basket of customers in the same city the past 2 weeks, and order amount z-score based on the past 12 weeks customer orders history. In some cases, the declarative framework module may enable generation of features on-demand. Users may generate on-demand features from another feature and request data. An example of an on-demand feature may be a time since a customer's last order. In this case, the point-in-time is not known prior to the request time and the timestamp of customer's last order can be a customer feature that is pre-computed by the feature engineering control platform.

In some embodiments, features extracted from data views can be added as respective columns to a view (e.g., an event view). A feature extracted from a data view can be added as a column to an event view when the feature's entity is included in the event view. Based on adding an extracted feature as a column to an event view, values can be aggregated as described with respect to any other column of a view. An addition of a feature to a view can enable computation of features such as customer average order size the last 3 weeks, where order size is a feature extracted from an item view (e.g., order details for an order event). An addition of a feature to a view can enable generation of more complex features, such as a feature for an average of ratings for restaurants visited by a customer in the last 4 weeks. In this case, the rating for each restaurant may be a windowed aggregation of ratings for the restaurant over a 1 year period of time. To speed up the computation of such complex features, the feature engineering control platform may accommodate the addition of a windowed aggregation feature by pre-computing historical values of the added feature and storing those historical values in an offline store.

In some embodiments, features for one entity can be converted into features for one parent entity of the entity when a child-parent relationship is established via a dimension table or a slowly changing dimension table. The new feature at the parent level may be a simple aggregate of the feature at the child level based on the child entity instances that are associated with the parent entity instance as at the point-in-time of the feature request or the point-in-time of the feature request minus an offset. Examples of such features can include a maximum of the sum of transaction amount over the past 4 weeks per credit card held by a customer. In this example, a sum of transaction amount over the past 4 weeks is a feature built at the credit card level that is aggregated at the customer level.

In some embodiments, an entity supertype may inherit the features of the subtypes of the entity supertype. The inherited features may be served (e.g., to an artificial intelligence model) without explicit specification of the subtype serving name and instance, such that only the supertype serving name and instance may be provided at serving time. In some cases, features from an entity supertype (or another subtype of the entity supertype) may not be used directly by the entity subtype of the entity supertype. Features from an entity supertype may be converted for use by the entity subtype of the entity supertype.

In some cases, the declarative framework module may enable generation of use cases. As described herein, a use case can describe a modeling problem to be solved and can define a level of analysis, the target object, and a context for how features are served. A use case may include a target recipe including a horizon and/or a blind spot for the target object, as well as any data transformations performed on the target object. Examples of use cases can include a churn of active customers for the next 6 months and fraud detection of transactions before payment. Formulation of use cases by the declarative framework module may better inform users of the feature engineering control platform of the context of feature serving. When a use case is associated with an event entity, the feature engineering control platform and the declarative framework module may be informed on the need to adapt the serving of features to the context. In some cases, the declarative framework module may support the mathematical formulation of use cases via the formulation of a context view and a target recipe, where a use case is defined based on a context view and target recipe. Based on mathematical formulation of use cases, observation sets (also referred to as “observation datasets”) specifically designed for the use cases may be generated for exploratory data analysis (EDA) of the features, training, retraining, and/or testing purposes as described herein at least in the section titled “Exemplary Techniques for Automatic Generation of Observation Sets.”

In some embodiments, use case primary entities may define a level of analysis of a modeling problem (e.g., modeling problem to be modeled by an artificial intelligence model). A use case may typically be associated with a single primary entity. In some cases, a use case may be associated with more than one entity. An example of a use case associated with more than one entity is a recommendation use case where two entities are defined for a customer and a product. Based on entity relationships of the use case entities (e.g., parent-child entity relationships and supertype-subtype entity relationships), the declarative framework module may automatically recommend parent entities and subtype entities for which features can be used or built for the use case. The features can indeed be directly served with the use case entities as the use case entities instances uniquely identify the instances of the parent entity or the subtype entity that defines the features. As an example, for a fraud detection use case where the primary entity is a transaction, features can be also extracted from the merchant entity, the credit card entity, the customer entity, and the household entity each corresponding to the transaction. Based on entity relationships of the use case entities, the declarative framework module (or feature discovery module) may also automatically recommend a data model of the use case. The data model of the use case may indicate (e.g., identify, list, etc.) all source data (e.g., tables) that can be used to generate features for the use case entity, the use case entity's parent entities, and/or the use case entity's subtype entities. Eligible tables may include tables where either the use case entities, the parent entities, the subtype entities, or their respective child or subtype entities are tagged.

In some embodiments, a context may define and indicate the circumstances in which a feature is expected to be served. Examples of contexts can include an active customer that has made at least one purchase over the past 12 weeks and a transaction reported as suspicious from a time period of reporting of the suspicious transaction to case resolution of the suspicious transaction. With respect to context formulation, minimum information provided by users to register and generate a context may include an entity to which the context is related, a context name, and a description of the context. In some cases, users may provide an expected inference time or expected inference time period for the context and a context view that mathematically defines the context. As an example, expected inference time can be any time (e.g., duration of time) or a scheduled time (e.g., scheduled duration of time). In some cases, an expected inference time may be an expected inference time period such as every Monday between 12:00 pm to 4:00 pm.

In some embodiments, a context view of a context may define the time periods during which each instance of the context entity is available for serving. An entity instance can be associated with multiple periods (e.g., non-overlapping periods). A context view may include respective columns for an entity serving key, a start timestamp, and an end timestamp. The end timestamp may be null when the entity key value is currently subject to serving (e.g., when a customer is active now). A context view may be generated in the data warehouse from source data or tables via the SDK of the feature engineering control platform. A context view may be generated via the SQL code received from a client computing device connected to the feature engineering control platform. In some cases, a context view may be generated via alternative techniques. In some cases, operations such as leads (e.g., where leads are opposite of lags as described herein) may be included in the SDK for a context view. In some cases, a context view can be treated as a slowly changing dimension table to retrieve entity instances (e.g., rows of table data corresponding to the entity) that are available for serving at any given point-in-time. A context view may be used by the feature engineering control platform to generate observation sets on-demand as described at least with respect to “Exemplary Techniques for Automatic Generation of Observation Sets.” In some embodiments, the context view is provided by a user, and the process of generating an observation set based on the context view has the effect of materializing (as the observation set) the context corresponding to the context view.

In some embodiments, a context may be associated with an event entity. When the context entity is an event entity, the information (e.g., context view and/or expected inference time or time period) corresponding to as context may be used by the feature engineering control platform to ensure that an end of a window of a feature aggregate operation is before a particular event's timestamp, thereby avoiding inclusion of the event in the aggregate operation used to generate a feature value. Such use of the context information may be critical for use cases (e.g., fraud detection) where useful features can include comparing a particular transaction with prior transactions. In some cases, further feature engineering may be used for context(s) associated with an event entity. For example, features may be generated based on an aggregation of event(s) that occurred after a particular event and before a point-in-time of the feature request.

In some embodiments, the declarative framework module may enable generation of target objects (also referred to as “targets”). A target object may be generated by a user by specifying a name of the target object and the entities with which the target object is associated. In some cases, for a target object, users may provide a description, a window size of forward operations or an offset from a slowly changing dimension table (each referred to as a “horizon”), a duration between a timestamp corresponding to computation of a target and a latest event timestamp corresponding to the event data used to compute the target (referred to as a “blind spot”), and a target recipe. A target recipe for a target may be defined similar to features as described herein. In some cases, a target recipe can be defined from (e.g., directly from) a slowly changing dimension view. In this case, users can specify an offset to define how much time in the future a status may be retrieved for the slowly changing dimension view. An example of such a target recipe may be marital status in 6 months. An example of a target defined by an aggregate as at a point-in-time may be a count of credit cards held by customer in 6 months.

In some embodiments, a target recipe can involve a forward aggregate operation. A forward aggregate operation for a target object may be defined similar to windowed aggregations generated from event views, time-series views and item views, or time-weighted aggregates over a window from slowly changing dimension views. To define a forward aggregation operation for a target object, users specify that the window operation is a forward window operation.

In some embodiments, a feature discovery module of the platform provider control plane may enable users to perform automated feature discovery for features that may be served by the feature engineering control platform. Semantic labels assigned to source data (e.g., columns of tables) by the data annotation and observability module may indicate the nature (e.g., ontology) of the source data. The declarative framework module as described herein may enable users to creatively manipulate source data (e.g., tables) to generate features and use cases. A feature store module may enable users to reuse generated features and push new generated features into production for serving (e.g., serving to artificial intelligence models). Based on the above-described modules, the feature discovery module may enable users to explore and discover new features that can be derived from source data (e.g., tables) stored by the data warehouse.

In some embodiments, feature discovery using the feature discovery module may be governed based on one or more principles. As an example, the feature discovery module may (1) enable suggestion of meaningful features (e.g., without suggesting non-meaningful features); (2) adhere to feature engineering best practices; and (3) suggest features that are inclusive of important signals of source data. The feature discovery module may rely on the data semantics added to source data (e.g., tables) to generate suggested features. If no data semantics are annotated to source data (e.g., a table), the feature discovery module may not be able to generate suggested features. The feature discovery module may codify one or more best practices for the data semantics added to the source data (e.g., table). The feature discovery module may automatically join tables based on the data transformations and manipulations described herein. The feature discovery module may automatically search features for entities that are associated with a primary entity.

In some cases, using the feature discovery module, users may request automated feature discovery by providing an input with the scope of a use case, a view and an entity, and/or a view column and an entity. Results of automated feature discovery performed by the feature discovery module may include feature recipe methods that are organized based on a theme. A theme may be a tuple including information for entities associated with a feature (referred to as a “feature entities”), primary table for the feature, and a signal type of the feature. As an example, feature discovery may be performed for an input of an event timestamp of a credit card transaction table for the customer entity. In some cases, to convert the output feature recipe methods into a feature, users can call the feature recipe method directly from the use case, the view, and/or the view column. In some cases, the feature discovery module may display, via the graphical user interface, information relating to helping a user convert the recipe method into a feature. As an example, the graphical user interface may display one or more parameters (e.g., window size) for a feature and computer code that can be used to alternatively generate the feature in the SDK.

In some embodiments, feature discovery performed by the feature discovery module can include combining operations such as joins, transforms, subsetting, aggregations, and/or post aggregation transforms. In some cases, users may provide an input selection to decompose combined operations, such that the feature discovery module provides suggestions for feature discovery at the individual operation level.

In some embodiments, the feature discovery module may include a discovery engine configured to search and provide potential features based on data semantics annotated for source data (e.g., tables), the type of the data, and whether an entity is a primary (or natural) key of the table. The discovery engine may generate features recipes for a received input based on executing a feature discovery method including a series of one or more joins, transforms, subsets, aggregations, and/or post aggregation transforms on tables. In some cases, transform recipes may be selected based on the data field semantics and outputs of the transform recipes may have new data semantics defined by the transform recipes. Subsetting may be triggered by the presence of an event type field in source data (e.g., a table). Aggregation recipes may be selected based on a function of the nature (e.g., ontology) of the source data (e.g., tables), the entity, and the semantics of the table's fields and respective transforms. Post aggregation transforms recipes may be selected based on the nature of the aggregations. Additional features of a feature discovery method performed by the feature discovery module are described herein at least in the section titled “Exemplary Techniques for Automated Feature Discovery.”

### Feature Cataloging

In some embodiments, modules of the feature engineering control platform corresponding to feature cataloging may include data catalog, entity catalog, use case catalog and feature catalog. In some cases, the data catalog module may include a data catalog that may be displayed via the graphical user interface. Using the data catalog, users of the feature engineering control platform may find and explore source data (e.g., tables) received from connected data sources and may add annotations to the source data (e.g., tables) (e.g., based on data semantics and data ontology as described herein). In some cases, using the data catalog, users may explore views shared by other users of the feature engineering control platform. In some cases, the entity catalog module may include an entity catalog that may be displayed via the graphical user interface. Using the entity catalog, users of the feature engineering control platform may find and explore entities associated with source data (e.g., tables) received from connected data sources. In some cases, users may add subtype-supertype annotations to entities to describe relationships between entities. In some cases, the use case catalog module may include a use case catalog that may be displayed via the graphical user interface. Using the use case catalog, users of the feature engineering control platform may find and explore use cases generated as described herein.

In some embodiments, the feature catalog module may include one or more feature lists available by a feature list catalog. A feature list may include a list of one or more features generated via the feature engineering control platform as described herein. Via the graphical user interface and using the feature catalog module, users may generate new feature lists, share the generated feature lists with other users, and/or reuse existing feature lists.

In some embodiments, a feature list can include features extracted for multiple entities, which may increase the complexity of serving the features included in the feature list. The feature catalog module may identify a feature list's primary entities to simplify serving of a feature list's features. The feature catalog may automatically identify primary entities of a feature list based on entity relationships (e.g., parent-child entity relationships). Each entity included in the feature list that has a child entity in the list may be represented by the respective child entity, such that the lowest level entities of the feature list are the primary entities of the feature list. Typically, such identification of primary entities based on entity relationships results in a single primary entity for a feature list and related use cases. In some cases, based on users needing to change the name of columns (referred to as “serving names”) of the feature data when a feature list is served, the original names of the features can be mapped to new serving names. By default, the serving names may be equivalent to the name of the features.

In some embodiments, the feature catalog module may enable users to identify and select relevant features for particular use cases via the graphical user interface. In some cases, the feature catalog module may automatically identify entities associated with a use case by searching for and identifying for parent entities of the use case's entities based on entity relationships. As an example, when a use case's primary entity is a credit card transaction, the related entities are likely to be a credit card, customer, and merchant.

In some embodiments, the feature catalog module may include a feature catalog of features associated with a use case's primary entities and the parent entities of the primary entities. To facilitate searches for features (e.g., features relevant to particular use cases) via the graphical user interface, the feature catalog may include and display features organized based on an automated tagging of a respective theme of each of the features. As described herein, a theme of a feature may be a tuple including a feature's associated entities, the feature's primary table, and the feature's signal type. The feature catalog module may automatically tag each generated feature with a respective theme and included signal type. A signal type may be automatically assigned to a feature based on the feature's lineage and the ontology of data used to generate the feature. Examples of signal types can include frequency, recency, monetary, diversity, inventory, location, similarity, stability, timing, statistic, and attribute signal types. To facilitate the selection of a particular feature by a user for serving, key information for the feature from the feature catalog may be displayed in the graphical user interface. The key information for the feature may include a readiness level of the feature (referred to as “feature readiness level”), an indication of whether the feature is used in production (e.g., served to artificial intelligence models for generation of production inferences), the feature's theme, the feature's lineage, the feature's importance with respect to a target object, and/or a visualization of the values of the feature distribution materialized with the use case's corresponding observation set that may be manually provided or automatically generated as described with respect to “Exemplary Techniques for Automatic Generation of Observation Sets.”

In some embodiments, the feature catalog module may include a feature list catalog of feature lists compatible with a use case. An individual feature list may be used directly for a particular use case and/or may be used as a basis for generating a new feature list. To facilitate the selection of a feature list for a use case, key information for the feature list from the feature catalog may be displayed in the graphical user interface. The key information for the feature list may include the status of the feature list, the percentage of features included in the feature list that are ready for production, the percentage of features included in the feature list that are served in production, the count (e.g., number) and list of features included in the feature list, and/or the count and list of entities and/or themes associated with the features included in the feature list. In some cases, themes (e.g., including signal types) that are not associated with features included in the feature list may be determined by the feature catalog module and may be displayed via the graphical user interface to provide an indication of potential area(s) of improvement for the feature list.

In some embodiments, the feature catalog module may enable a feature list builder available via the graphical user interface. Features and/or feature lists may be added to the feature list builder via the graphical user interface. The feature list builder may enable a user to add, remove, and modify features included in the feature lists. In some cases, the feature list builder may automatically determine and display statistics on the percentage of features ready for production and the percentage of features served in production. The displayed statistics may provide an indication to users on the readiness level of their selected features and may encourage reuse of features. In some cases, the feature catalog module may automatically determine and cause display of recommendations for themes of features to include in a feature list. The feature catalog module may determine themes that are not associated with features included in a feature list and may inform users of the missing themes, thereby enabling users to search for features covering the respective missing themes.

In some embodiments, the execution graph module may enable generation of one or more execution query graphs via the graphical user interface. An execution query graph may include one or more features that are converted into a graphical representation of intended operations (e.g., data transformations and/or manipulations) directed to source data (e.g., tables). An execution query graph may be representative of steps used to generate a table view and/or a group of features. An execution query graph may capture and store data manipulation intentions and may enable conversion of the data manipulation intentions to different platform-specific instructions (e.g., SQL instructions). A query execution graph may be converted into platform-specific SQL (e.g., SnowSQL or SparkSQL) instructions, where transformations included in the instructions are executed when their values are needed (e.g., only when their values are needed), such as when a preview or a feature materialization request is performed. Additional features of generation of an execution query graph by the execution graph module are described herein at least in the section titled “Exemplary Techniques for Generating an Execution Graph.”

### Feature Jobs and Serving

In some embodiments, modules of the feature engineering control platform corresponding to feature jobs and serving may include feature store and feature job orchestration modules. In some cases, a feature store module may be stored and may operate in a client's data platform (e.g., cloud data platform). The feature store module may include an online feature store and an offline feature store that are automatically managed by the feature store module to reduce latencies of feature serving at training and inference time (e.g., for artificial intelligence model(s) connected to the feature engineering control platform). In some cases, orchestration of the feature materialization in the online and/or offline feature stores may be automatically triggered by the feature job orchestration module based on a feature being deployed according to a feature job setting for the feature. Materialization (e.g., computation) of features may be performed in the client's data platform and may be based on metadata received from the platform provider control plane.

In some embodiments, the feature store module may compute and store partial aggregations of features referred to as “tiles.” Use of tiles may reduce and optimize the amount of resources used to serve historical and online requests for features. The feature store module may perform computation of features using incremental windows corresponding to tiles (e.g., in place of an entire window of time corresponding to a feature). In some cases, tiles generated by the feature store module may include offline tiles and online tiles. Online tiles may correspond to deployed features and may be stored in the online feature store. Offline tiles may correspond to both deployed and non-deployed features and may be stored in the offline feature store. If a feature is not deployed, offline tiles corresponding to the feature may be generated and cached based on reception of a historical feature request at the feature store module. Caching the offline tiles may reduce the latency of responding to subsequent historical feature requests. Based on deployment of a feature, offline tiles may be computed and stored at a same schedule as online tiles based on feature job settings of the feature job orchestration module.

In some embodiments, use of tiles by the feature store module may optimize and reduce storage relative to storage of offline features. Optimization and reduction of storage may be based on tiles being: (1) sparser than features; and (2) shared by features computed using the same input columns and aggregation functions, but using different time windows or post aggregations transforms. In some cases, based on online tiles being potentially exposed to incomplete source data received from connected data sources, the feature store module may recompute the online tiles at execution of each feature job and may automatically fix inconsistencies in the online tiles. The feature store module may compute offline tiles when a risk of incomplete data impacting computation of the offline tiles is determined to be negligible.

In some embodiments, the feature job orchestration module may control and implement feature job scheduling to cause the feature store module to compute and generate features based on tiles stored by the feature store module. The feature store module may exclude the most recent source data received from the connected data sources when computing online features (e.g., based on online tiles). A duration between a timestamp corresponding to computation of a feature and a latest event timestamp corresponding to the event data used to compute the feature may be referred to as a blind spot as described herein. Each feature of the feature engineering control platform may be associated with one or more feature versions. Each feature version may include metadata indicative of feature job scheduling for the feature and a blind spot corresponding to computation of the feature. The metadata indicative of feature job scheduling may be added to a feature automatically during the feature declaration or manually when a new feature version is created.

In some embodiments, the feature job orchestration module may automatically analyze the record creation (e.g., a frequency of record creation) of data sources (e.g., source tables) for event data. The feature job orchestration module may analyze record creation for event data based on annotated record creation timestamps added to event data by a user. Analysis of record creation of data sources (e.g., source tables) for event data may include identification of data availability and data freshness for the event data based on timestamps associated with rows of the event data, record creation timestamps added to event data, and/or a rate at which the event data is received and/or updated from the data source. Based on analysis of record creation for event data, the feature job orchestration module may automatically recommend a default setting for the feature job scheduling and/or the blind spot duration for the event data (e.g., event table).

The default setting may include a selected frequency for feature job execution to compute a particular feature and a selected duration for a blind spot between a timestamp at which a feature is computed and a latest event timestamp of the event data used to compute the feature. In some cases, an alternative feature job setting may be selected by a user in connection with the declaration of the event table or feature. A user may select an alternative feature job setting when the user desires a more conservative (e.g., increased) blind spot parameter and/or a less frequent feature job schedule. Additional descriptions of automated feature job scheduling are described herein at least in the section titled “Exemplary Techniques for Automated Feature Job Setting.”

In some embodiments, the feature store module may serve computed features (referred to as “feature serving”) based on receiving feature requests. A feature request may be manually triggered by the user or may originate from an external computing system that is communicatively connected to the feature engineering control platform. Examples of the external computing systems can include computing systems associated with artificial intelligence models that may perform training activities and generate predictions based on features received from the feature engineering control platform. Feature requests may include historical requests and online requests. In some cases, serving of historical features (referred to as “historical feature serving”) based on historical requests can occur any time after declaration of a feature list. Historical requests may typically be made for EDA, training, retraining, and/or testing purposes.

In some embodiments, a historical request should include an observation set that specifies historical values of a feature list's entities (e.g., primary entities) at respective historical points in time (e.g., corresponding to timestamps). In some cases, a historical request may include the context and/or the use case for which the historical request is made. When a feature list served in response to a historical request includes one or more on-demand features, the historical request may include indication of information needed to compute the on-demand features. A feature served in response to a historical request is materialized using information available at the historical points-in-time indicated by the historical request (e.g., without using information unavailable at that historical point-in-time). For example, a feature served for a historical request may be materialized based on source data available before and/or at the historical points-in-time of the historical request.

In some embodiments, when a use case is formulated mathematically with a context view and an expected inference time, observation set(s) designed for the use case may be automatically generated by the declarative framework module as described herein. For the declarative framework module to automatically generate the observation set(s), a user may provide a use case name and/or a context name; start and end timestamps to define the time period of the observation set; the maximum desired size of the observation set; a randomization seed; and/or for a context for which the entity is not an event entity, the desired minimum time interval between two observations of the same entity instance. The default value of the desired minimum time interval may be equal to the target object's horizon if known.

In some embodiments, the feature engineering control platform may prompt the user to provide the above-described information. When a use case has a defined target recipe, the target object may be automatically included in the observation set. Observation sets automatically generated as described herein may be used for EDA, training, re-training, and/or testing of artificial intelligence models. Additional descriptions of automatic generation of observation sets are described herein at least in the section titled “Exemplary Techniques for Automatic Generation of Observation Sets.”

In some embodiments, serving of online features (referred to as “online feature serving”) based on online requests can occur any time after declaration and deployment of a feature list. A feature list may be deployed without use of separate pipelines and/or tools external to the feature engineering control platform. A feature list may be deployed via the graphical user interface or the SDK of the feature engineering control platform. Orchestration of feature materialization into the online feature store is automatically triggered by feature job scheduling. Online features may be served in response to online requests via a REST API service.

In some embodiments, an online request may include an instance of a feature list's entities (e.g., primary entities) for which an inference is needed. In some cases, an online request may include the context and/or the use case for which the online request is made. For the inference of contexts with an event entity, an online request may include an instance of the entities attributes that are not available yet at inference time. When a feature list served in response to an online request includes one or more on-demand features, the online request may include indication of information needed to compute the on-demand features.

In some embodiments, deployment of a feature list may be disabled any time via the feature engineering control platform. Deployment of a feature list may be disabled when online serving of the feature list is not needed (e.g., by an external computing system). Contrary to a log and wait approach, disabling the deployment of a feature by the feature engineering control platform does not affect the serving of received historical requests.

### Feature Management

In some embodiments, modules of the feature engineering control platform corresponding to feature management may include feature governance, feature observability, feature list deployment, and use case management modules. In some cases, a feature governance module may enable governance and control of versions of features and feature lists generated by the feature engineering control platform. The feature governance module may automatically generate new versions of features and feature lists and may track each version of a feature and feature list generated as described herein. The feature governance module may automatically generate new versions of features when new data quality issues arise and/or when changes occur to the management of source data corresponding to a feature. The feature governance module may generate a new version of a feature without disruption to the serving of the deployed version of the feature and/or a feature list including the deployed version of the feature.

In some embodiments, each version of a feature (referred to as a “feature version”) may have a feature lineage. A feature lineage may include first computer code (e.g., SDK code) that can be used to declare a version of a feature and second computer code (e.g., SQL code) that can be used to compute a value for the version of the feature from source data. A feature lineage for a feature version may enable auditing of the feature version (e.g., prior to deployment of the feature) and derivation of features similar to the feature version in the future. In some cases, each version of a feature and/or a feature list may include a readiness level or status indicative of whether the respective feature and/or feature list is ready for deployment and production operation.

In some embodiments, support of versioning for features may mitigate and manage undesirable changes in the management or the data quality of source data received from data sources. When changes occur to the management of the data sources (e.g., source tables), the feature governance module may enable (1) selection of a new default schedule for a feature job setting at the table level and (2) generation of a new version of a feature based on the new feature job setting. When changes occur to the data quality of the data sources (e.g., source tables), feature governance module may enable annotation of new default cleaning steps to columns of the table that are affected by the changes and facilitation of generating new feature versions for features that use the affected columns as an input for feature computation. When a new version of a feature is generated, the feature engineering control platform may continue to serve older versions of the feature in response to historical and/or online requests (e.g., to not disrupt the inference of artificial intelligence operations tasks that rely on the feature).

In some embodiments, with respect to changes to data quality annotation when a column of a table is not used by a feature, data quality information associated with the column can be updated without disruption to feature serving. When a column of a table is used by a feature, users may (1) formulate a plan to including an indication of how a change to the column may impact the feature versions; and (2) submit the plan for approval before making changes to data quality annotation for the column. The plan may indicate any variations to cleaning settings, and whether to override current feature versions, create new feature versions, or perform no action. From the plan and via the graphical user interface, users may receive indications of feature versions that have inappropriate data cleaning settings and feature list versions including the respective feature versions that have inappropriate data cleaning settings.

In some embodiments, with respect to changes to data quality annotation when a column of a table is used by a feature, the feature engineering control platform may recommend generating new feature versions in place of overwriting current feature versions. To aid evaluation of the impact of changes to data quality annotation, users can materialize the affected features before and after the changes by selecting an observation set for materialization of the features. Based on definition of new data quality annotation (e.g., cleaning step) settings for each affected feature version, a user may submit the plan via the graphical user interface. Based on approval of the plan (e.g., via an administrator or another individual accessing the feature engineering control platform), the changes included in the plan may be applied to the table to cause generation of new feature versions. When an option of a new feature version generation is selected in the plan, the new feature version inherits the readiness level of the older feature version and the older feature version is automatically deprecated. When the old feature version is the default version of the feature, the new feature version may automatically become the default version.

In some embodiments, the feature governance module may support one or more modes for feature list versioning. In some cases, a first mode of the one or more modes may be an automatic mode. Based on a feature list having an automatic mode for versioning, the feature governance module may cause automatic generation of new version of the feature list based on changes in version of feature(s) included in the feature list. A new default version of the feature list may then use the current default versions of the features included in the feature list. In some cases, a second mode of the one or more modes may be a manual mode. Based on a feature list having a manual mode for versioning, users may manually generate a new version of a feature list and new versions of a feature list may not be automatically generated. The feature versions that are specified by a user may be changed in the new feature list version relative to an original feature list version (e.g., without changing the feature versions of other features). Feature versions that are not specified by a user may remain the same as the original feature list version. In some cases, a third mode of the one or more modes may be a semi-automatic mode. Based on a feature list having a semi-automatic mode for versioning, the default version of the feature list may include current default versions of features except for feature versions that are specified by a user.

In some embodiments, each feature version may have a respective feature lineage including include first computer code (e.g., SDK code) that can be used to declare a version of a feature and second computer code (e.g., SQL code) that can be used to compute a value for the version of the feature from source data. The first computer code may be displayed via the graphical user interface based on selection of a feature version's feature lineage. In some cases, the displayed first code (e.g., SDK code) is pruned to display only steps related to the feature and automatically organized based on key steps (e.g., key steps such as joins, column derivations, aggregation, and post aggregation transforms).

In some embodiments, the feature governance module may determine and associate a feature readiness level with each feature version. The feature governance module may support one or more feature readiness levels and may automatically determine a feature readiness level for a feature version. A first level of the one or more feature readiness levels may be a production ready level that indicates that a feature version is ready for production. A second level of the one or more feature readiness levels may be a draft level that indicates that a feature version may be shared for training purposes (e.g., only for training purposes). A third level of the one or more feature readiness levels may be a quarantine level that indicates that a feature version has recently experienced issues, may be used with caution, and/or is under review for further evaluation. A fourth level of the one or more feature readiness levels may be a deprecated level that indicates that a feature version is not recommended for use for training and/or online serving. In some cases, the feature governance level may automatically assign the quarantine level to a feature version when issues are raised. The quarantine level may provide an indication (e.g., reminder) to users of a need for remediation actions for the feature including actions to: fix data warehouse jobs, fix data quality issues, and/or generate new feature versions to serve healthier features versions for retraining and/or production purposes. When requests call for a feature without specifying the feature's version, the default version is returned in response to the request. In some cases, a “default version” a feature as referred to herein may be the feature version that has a highest readiness. In some cases, the default version of a feature may be manually specified by a user via the graphical user interface.

In some embodiments, the feature governance module may determine and associate a respective status for each feature list. The feature governance module may support one or more feature list statuses and may automatically determine a status for a feature list. A first status of the one or more feature list statuses may be a deployed status that indicates that at least one version of a feature list is deployed. A second status of the one or more feature list statuses may be a template status that indicates that a feature list may be used as a reference (e.g., a safe starting point) to generate additional feature lists. A third status of the one or more feature list statuses may be a public draft status that indicates that a feature list is shared with users to solicit comments and feedback from the users. A fourth status of the one or more feature list statuses may be a draft status that indicates that a feature list may only be accessed by an author of the feature list and is unlikely to be deployed as-is. A feature list having a draft status may be generated by users running experiments for a particular use case. A fifth status of the one or more feature list statuses may be a deprecated status that indicates that a feature list may be outdated and is not recommended for use.

In some embodiments, with respect to feature list statuses, before a feature list may be assigned a template status, a description may be associated with the feature list and each of the features included in the feature list may have a production ready feature level for feature readiness. In some cases, the feature governance module may automatically assign a deployed status to a feature list when at least one version of the feature list is deployed. When deployment is disabled for each version of a feature list, the feature governance module may automatically assign a public draft status to the feature list. In some cases, only feature lists having a draft status may be deleted from the feature engineering control platform. In some cases, to inform users on the readiness of a feature list, each feature list may have a respective readiness metric (e.g., readiness percentage, ratio, score, etc.) that indicates the percentage of the feature list's features that have a production ready level. Feature readiness levels and feature list statuses may enable and facilitate development and sharing of features and feature lists in an enterprise environment that uses the feature engineering control platform.

In some embodiments, a feature observability module may enable consistency monitoring of features and feature lists generated by the feature engineering control platform. The feature observability module may monitor both training and serving consistency of features derived from event data and item data included in the table and may detect issues (e.g., incorrect feature job settings, late updates to records included in source data, and data warehouse job failures) associated with features, such that the issues may be identified for review and remediation by users of the feature engineering control platform. The feature observability module may monitor both training and serving consistency (also referred to as “offline and online consistency”) of features that are not served in production. In some cases, the feature observability module may monitor consistency of features that are based on event data (e.g., an event table) based on the record creation timestamp data (e.g., column data) associated with the event data. The feature observability module may detect issues with features when the features are and are not served.

In some embodiments, the feature observability module may monitor event data included in the data warehouse. Monitoring the event data may include comparing the event data used for training and serving of features to evaluate the consistency between the data availability and data freshness of the event table over time. Based on monitoring the event data, the feature observability module may identify issues with the event table such as: delayed creation of the event records (e.g., rows) included in the event table, delayed ingestion of the event data by the data warehouse (referred to as “delayed warehouse updates”), and failures to record event records in event table (e.g., missing data warehouse updates). Based on identification of issues with the event table, the feature observability module may provide indications of the identified issues that may be displayed via the graphical user interface for user evaluation. In some cases, based on the monitoring, the feature observability module may identify changes to table schema (e.g., types of columns) for event data included in the table and may provide an indication of such identified changes via the graphical user interface.

In some embodiments, the feature observability module may monitor correctness of default feature job settings to determine whether the feature job settings for executing feature jobs (e.g., refresh of the offline and online feature stores) for a feature are appropriate. The feature observability module may determine whether feature job settings are appropriate by determining whether the event data needed to execute the feature job is available and received as needed from the data source and/or is updated with a frequency that is appropriate for the scheduling of the feature job. As an example, feature job settings for a feature may be inappropriate and may be remediated when the event data used to compute the feature is updated at a frequency less than the frequency of feature job scheduling and/or when the event data is unavailable (e.g., not yet available) for execution of a feature job. The feature observability module may identify when feature job settings for a feature are inappropriate and may provide a prompt for a new feature job setting via the graphical user interface.

In some embodiments, based on the monitoring, the feature observability module may identify feature versions that are exposed to offline and online inconsistency and the source(s) (e.g., event data) of the inconsistency. The graphical user interface may provide and display the indications of feature versions that are exposed to offline/online inconsistency and the source(s) of the inconsistency. The feature observability module may automatically assign a quarantine status to identified feature versions that are exposed to offline/online inconsistency, thereby providing an indication to users using the feature versions of remediation actions for the feature versions as described herein. The graphical user interface may display automatically suggested settings for quarantined feature versions. The feature observability module may automatically assign a quarantine status to feature lists including the quarantined feature versions. The feature observability module may automatically generate new versions of feature lists based on the new features versions for the quarantined feature versions. Automatic generation of new feature list versions may prevent users from training artificial intelligence models using unhealthy feature lists.

In some embodiments, for online features, the feature observability module may monitor a consistency of offline and online tiles. Based on a detection of an inconsistency for a tile, the feature observability module may automatically fix the inconsistency to reduce a duration of the impact of the inconsistency on serving of a feature corresponding to the tile. In some cases, the feature observability module may evaluate offline and online consistency of online requests based on a sample of the requests. In some cases, the feature observability module may determine and provide an indication of a source of an inconsistency for a feature when a record creation timestamp was specified for event data used to generate the feature.

In some embodiments, a feature list deployment module may enable deployment and retraction of feature lists generated by the feature engineering control platform. A feature list may be deployed to enable serving of features included in the feature list for a number of use cases. Feature lists may be deployed and/or retracted from deployment for a given use case via the graphical user interface of the feature engineering control platform without disrupting the serving of the other use cases.

In some embodiments, a use case management module may enable management of use cases generated via the feature engineering control platform. The use case management module may enable request tracking for each use case identification of feature list(s) deployed for each use case. The use case management module may enable the storage of observation sets used for a use case and provides the observation sets for future historical requests of other feature lists. The use case management module may cache EDA for features. The use case management module may report issues escalated by the feature observability module when the affected features are served for the use case. The use case management module may enable monitoring of use case accuracy.

### Exemplary Techniques for Automatic Generation of Observation Sets

In some embodiments, as described herein, the declarative framework module may automatically generate observation set(s) for EDA, training, and/or testing purposes. Observation sets generated via the techniques described herein may avoid data leakage deficiencies based on use of points-in-time that are representative of past inference times associated with use cases. The declarative framework module may generate an observation set for a use case based on one or more algorithmic techniques. To automatically generate the observation set(s), a user may provide inputs including a use case name or a context name to identify a respective use case or context; start and end timestamps to define a time period of the observation set; the maximum desired size (e.g., number of rows) of the observation set; and/or a randomization seed.

In some embodiments, the randomization seed is a value used to initialize (e.g., “seed”) a random number generator (RNG), which can then be used to generate a sequence of random points-in-time. In some embodiments, subsequently re-initializing the RNG with the same randomization seed configures the RNG to produce the same sequence of random points-in-time. Thus, the randomization seed facilitates the repeatable production of a sequence of random numbers, which can be particularly useful in scientific experiments, simulations, computer programming, data sampling, and other applications that can benefit from reproducibility. For example, when the values generated by the RNG are used to randomly select entity instances (e.g., rows of a table) for inclusion in an observation data set, use of a randomization seed renders the sampling step reproducible.

In some embodiments, the feature engineering control platform may prompt the user to provide such inputs. In some cases, for a context view having an entity that is an event entity, a user can optionally select a probability for an entity instance to be randomly selected. A user may select a probability for an instance to be randomly selected to be equal for each entity instance or to be proportional to the duration between the start and end timestamps defining a time period for the observation set. In some cases, for a context view having an entity that is not an event entity, users can optionally provide a desired minimum time interval between a pair of observations of the same entity instance. The desired minimum time interval may not be lower than the inference period (e.g., “target horizon”) and a default value for the desired minimum time interval may be greater than the inference period.

As used herein, “inference period” (or “target horizon”) can refer to the time frame associated with a prediction or forecast. In the context of churn prediction for the next 6 months, the “inference period” refers specifically to that 6-month period. In the context of meteorology, the inference period for forecasting the weather is often the next few days or weeks. In the context of supply chain and inventory management, models may be used to forecast demand for products over various inference periods (e.g., the next month, next quarter, or next year). In some contexts (e.g., the classification of past events, as in fraud detection), the concept of an inference period may not apply (and can be considered as null) because the goal may be to classify an event (e.g., identify a fraudulent transaction) as it occurs or after it has occurred, rather than predicting the occurrence of the event over a future time frame.

In some embodiments, for a use case corresponding to a context view having an entity that is an event entity, the declarative framework module may automatically generate an observation set based on a number of steps. To generate the observation set, a dataset is initially equal to the context view that is associated with the provided context or use case. From the dataset and above-described inputs, the declarative framework module may select entity instances (e.g., rows) from the dataset that are subject to materialization (e.g., have timestamps within or durations that intersect the observation period) during the observation period. To select entity instances (e.g., rows) that are subject to materialization during the observation period, the declarative framework module may (1) remove entity instances (e.g., rows) from the dataset that have a start timestamp that is greater than the input observation end timestamp; and (2) remove entity instances (e.g., rows) from the dataset that have an end timestamp that is less than the input observation start timestamp. Based on selecting entity instances (e.g., rows) that are subject to materialization during the observation period, the declarative framework module may clip entity instances with start timestamps and end timestamps that are outside the observation period to fit within the edges (e.g., corresponding to the input start and end timestamps) of the observation period. For example, an entity with a duration that begins before the start of the observation time period and ends at a point within the observation time period may be truncated to generate a clipped entity with a start timestamp corresponding to the start time of the observation time period and an end timestamp corresponding to the end timestamp of the original entity. Similar methods may be used to generate clipped entities for entities with start timestamps within the observation time period and end timestamps after the end of the observation time period.

In some embodiments, based on clipping the start timestamps and end timestamps of entity instances that are outside the observation period, the declarative framework module may randomly generate a point-in-time for each entity instance that is between the start timestamp and end timestamp of the respective entity instance (e.g., row) of the dataset. When a probability for an entity instance (e.g., row) of the dataset to be randomly selected for inclusion in the observation set is selected to be proportional to the duration between the start and end timestamps of the observation period, the declarative framework module may compute a duration between the start timestamp and end timestamp of the observation period to determine a maximum duration for all entity instances included in the dataset. Based on determining the maximum duration, the declarative framework module may assign, to each instance of the dataset, a respective probability equal to a duration of the respective instance (e.g., as defined by the instance's start and end timestamps) divided by the determined maximum duration. Based on assigning a respective probability to each instance of the dataset, the declarative framework module may select entity instances (e.g., rows) from the dataset for inclusion in the observation set based on a Bernoulli distribution and each instance's respective probability. Entity instances of the dataset that are not selected for inclusion in the observation set may be discarded. When a number of selected entity instances for inclusion in the observation set is greater than the input maximum desired size of the observation set, the declarative framework module may randomly select entity instances from the originally selected entity instances to match the maximum desired size of the observation set, such that the observation set includes a number of entity instances equal to the maximum desired size of the observation set. The generated observation set may be made available by the declarative framework module for feature historical requests.

When a probability for an instance (e.g., row) of the dataset to be randomly selected for inclusion in the observation set is selected to be equal for each instance, the declarative framework module may select entity instances (e.g., rows) from the dataset for inclusion in the observation set based on a Bernoulli distribution and each instance's respective probability. The probability may be equal to the maximum desired size (e.g., number of rows) of the observation set divided by the number of instances. Entity instances of the dataset that are not selected for inclusion in the observation set may be discarded. When a number of selected entity instances for inclusion in the observation set is greater than the input maximum desired size of the observation set, the declarative framework module may randomly select entity instances from the selected entity instances to match the maximum desired size of the observation set, such that the observation set includes a number of entity instances equal to the maximum desired size of the observation set. The generated observation set may be made available by the declarative framework module for feature historical requests.

In some embodiments, for a use case corresponding to a context view having an entity that is not an event entity, the declarative framework module may automatically generate an observation set based on a number of steps. To generate the observation set, a dataset may be initially equal to the context view that is associated with the provided context or use case. From the dataset and above-described inputs, the declarative framework module may modify the desired minimum time interval between 2 observations of the same entity instance. When an inference time for the use case is at any time, the declarative framework module may modify the minimum time interval to be (1) greater than the original minimum interval; and (2) not a multiple of rounded hours to avoid the same entity instance having multiple points-in-time at the same time of the day and/or week. As an example, a minimum time interval of 7 days may be modified by the declarative framework module to be 7 days 1 hour and 13 minutes. When an inference time for the use case is at regular interval (e.g., every Monday between 3 to 6) and when the inference time period for the use case is greater the minimum time interval, the declarative framework module may modify the minimum time interval to be equal to the inference time period. When an inference time for the use case is at regular interval and when the interface period is not greater the minimum time interval, the declarative framework module may modify the minimum time interval such (1) the modified minimum interval is a multiple of the inference time period; and (2) the modified minimum interval is greater than the original minimum interval.

In some embodiments, based on modifying the minimum interval, the declarative framework module may select entity instances (e.g., rows) from the dataset that are subject to materialization during the observation period. To select entity instances (e.g., rows) that are subject to materialization during the observation period, the declarative framework module may (1) remove entity instances (e.g., rows) from the dataset that have a start timestamp that is greater than the input observation end timestamp; (2) remove entity instances (e.g., rows) from the dataset that have an end timestamp that is less than the input observation start timestamp; and (3) remove duplicated entity instances. Based on selecting entity instances (e.g., rows) that are subject to materialization during the observation period, the declarative framework module may generate a random point-in-time for each instance (e.g., row) included in the dataset. To generate a random point-in-time for each instance (e.g., row) included in the dataset and when the inference time is any time, the declarative framework module may randomly select the random point-in-time from a period starting at the start timestamp of the observation period and ending at a sum of the start timestamp of the observation period and the minimum time interval. To generate a random point-in-time for each instance (e.g., row) included in the dataset and when the inference time is at a scheduled interval, the declarative framework module may randomly select the random point-in-time from the inference periods (as defined by the scheduling of the inference) that are within a period starting at the start timestamp of the observation period and ending at a sum of the start timestamp of the observation period and the minimum time interval.

In some embodiments, based on generating a respective random point-in-time for each instance of the dataset, the declarative framework module may generate an additional instance (e.g., rows) in the dataset by incrementing the original point-in-time with the minimum time interval. The declarative framework module may repeatedly generate additional entity instances (e.g., rows) in the dataset by incrementing the original point-in-time with a multiple of the minimum time interval until the generated point-in-time is greater than the end timestamp of the observation period. Based on generating one or more additional entity instances in the dataset, the declarative framework module may remove entity instances from the dataset that have a respective point-in-time greater than the end timestamp of the observation period. Based on removing the entity instances from the dataset, the declarative framework module may remove entity instances from the dataset for which the entity instance is not subject to materialization at the point-in-time of the context view used to generate the observation set. The declarative framework module may select the remaining entity instances included in the dataset for inclusion in the generated observation set. When a number of selected entity instances for inclusion in the observation set is greater than the input maximum desired size of the observation set, the declarative framework module may randomly select entity instances from the selected entity instances to match the maximum desired size of the observation set, such that the observation set includes a number of entity instances equal to the maximum desired size of the observation set. The generated observation set may be made available by the declarative framework module for feature historical requests.

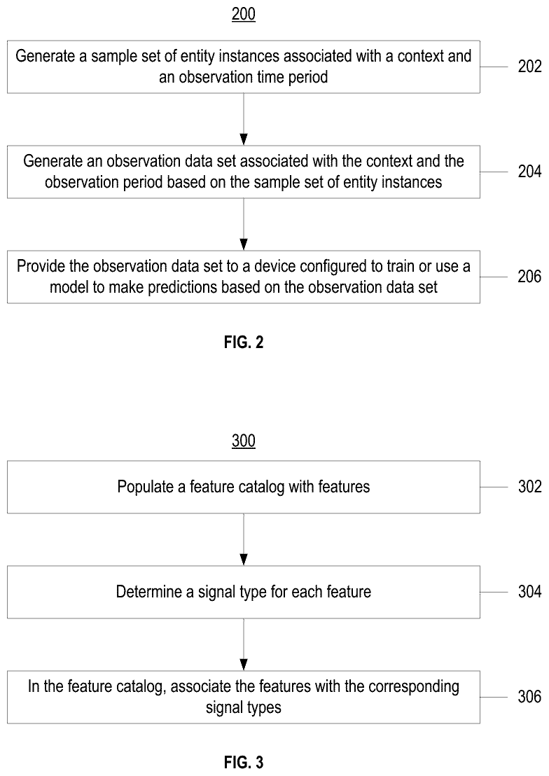

FIG. 2 is a flow diagram of an example method 200 for generating an observation data set, in accordance with some embodiments. The method 200 may be performed, for example, by the feature engineering control platform 100. The method 200 may include steps 202-206.

In step 202, the platform generates a sample set of entity instances associated with a context and an observation time period. An indication of the context and the observation time period may be received by the platform. Generating the sample of entity instances may include selecting a first subset of entity instances from a plurality of entity instances. Each entity instance in the first subset of entity instances may be associated with the context and with one or more timestamps that intersect the observation time period. Generating the sample set of entity instances may further include selecting a second subset of entity instances from the first subset of entity instances based on the one or more timestamps associated with the first subset of entity instances. The second subset of entity instances may be the sample set of entity instances.

In some embodiments, the sample set of entity instances includes values of one or more features. In some embodiments, the method 200 further includes analyzing the one or more features. Analyzing the one or more features may include performing statistical analysis of the values of the one or more features. In some embodiments, a signal type has been automatically assigned (e.g. by the platform) to each feature included in the one or more features.

In some embodiments, selecting the second subset of entity instances from the first subset of entity instances includes identifying an entity instance in the first subset of entity instances having a start timestamp earlier than a start time of the observation time period and an end timestamp within the observation time period. In some embodiments, selecting the second subset of entity instances from the first subset of entity instances further includes generating a clipped entity comprising entity data of the entity instance between the start time of the observation time period and the end timestamp of the entity. In some embodiments, selecting the second subset of entity instances from the first subset of entity instances further includes adding the clipped entity to the second subset of entity instances.

In step 204, the platform generates an observation data set associated with the context and the observation time period based on the sample set of entity instances. In some embodiments, generating the observation data set includes selecting at least one feature from the one or more features of the sample set of entity instances and adding the at least one selected feature to the observation data set. In some embodiments, the selecting of the at least one feature is based on the statistical analysis of the values of the one or more features.

In step 206, the platform provides the observation data set to a device configured to train or use a model to make predictions based on the observation data set.

In some embodiments, the indication of the context identifies an event entity, and the plurality of entity instances is a plurality of event entity instances corresponding to the event entity. In some embodiments, selecting the second subset of entity instances from the first subset of entity instances includes, for each entity instance in the first subset of entity instances, probabilistically adding the entity instance to the second subset of entity instances based on a selection probability associated with the entity instance. In some embodiments, the selection probability associated with the entity instance is based on the one or more timestamps associated with the entity instance. In some embodiments, the one or more timestamps associated with the entity instance include a start timestamp and an end timestamp, and the selection probability associated with the entity instance depends on a difference between the end timestamp and the start timestamp. In some embodiments, the plurality of event entity instances correspond to a plurality of event durations. Each event duration may be equal to a difference between the end timestamp and the start timestamp of the corresponding event entity instance. In some embodiments, method further includes determining a maximum event duration among the plurality of event durations. In some embodiments, the selection probability associated with the entity instance is based on a ratio between the event duration corresponding to the entity distance and the maximum event duration.

In some embodiments, the indication of the context identifies a particular entity other than an event entity, and the plurality of entity instances correspond to the particular entity. In some embodiments, selecting the second subset of entity instances from the first subset of entity instances includes sampling the first subset of entity instances. A minimum sampling interval may be enforced when sampling the first subset of entity instances. In some embodiments, the indication of the context identifies a target object and an inference period associated with the target object. In some embodiments, the method further includes adjusting a value of the minimum sampling interval such that the adjusted value of the minimum sampling interval is greater than the inference period. In some embodiments, the method further includes adjusting a value of the minimum sampling interval such that the adjusted value of the minimum sampling interval is not an integer multiple of one hour.

In some embodiments, selecting the second subset of entity instances from the first subset of entity instances includes, for each entity instance in the first subset of entity instances, (a) randomly selecting a point-in-time from a time period beginning at a start time of the observation time period and having a duration matching the minimum sampling interval; (b) adding the entity instance to the second subset of entity instances if the point in time is less than or equal to an end time of the observation time period and less than or equal to an end timestamp of the entity instance; (c) increasing the point-in-time by the minimum sampling interval; and (d) repeating sub-steps (b)-(d) until the point-in-time is greater than end time of the observation time period or greater than the end timestamp of the entity instance.

### Exemplary Techniques for Automated Feature Job Setting

In some embodiments, as described herein, the feature job orchestration module may automatically analyze data availability and data freshness (e.g., how recently the data was collected) of source data (e.g., event data) received and stored in the data warehouse. Based on the automatic analysis of the data availability and data freshness of source data, the feature job orchestration module may determine and provide a recommended setting for feature job scheduling and a blind spot for materializing feature(s) derived from the analyzed source data. Analysis of data availability and data freshness of source data may be based on record creation timestamps added to event data by user(s).

To determine and provide a recommended setting for feature job scheduling and an associated blind spot, the feature job orchestration module may determine an estimate of a frequency at which the event data is updated in the data warehouse based on a distribution of inter-event time (IET) of a sequence of the record creation timestamps corresponding to the event data. The IET between successive record creation timestamps may indicate a frequency at which the event data is updated in the data warehouse. The feature job scheduling module may determine and provide a recommendation of the feature job frequency period that is equal to a best estimate of the refresh frequency of the event data's data source. The best estimate of the refresh frequency of the event data's data source may be based on modulo operations between the distribution of the IET and one or more estimated refresh periods. In some situations, these modulo operations may produce a distribution of outputs. In one example, a frequency period estimate may be the division of the true frequency period by an integer. In this example, the results of the modulo operation may either produce two distinct peaks of results with one peak near zero and the other peak near the value for the frequency period estimate. In another example, the frequency estimate may be a multiple of the true frequency period, which can result in a distribution of IET modulo results over two or more areas or peaks, or two peaks that are neither close to zero nor the frequency estimate. In cases where the frequency estimate falls into neither of the aforementioned scenarios, the IET modulo operation result spread may be roughly evenly spread between zero and the estimate.

Searching for the true frequency period can start with an initial guess (e.g., based on the randomization seed) rounded to the nearest appropriate time unit, such as minutes or seconds. Based on the above-described patterns, the guess can be progressively refined by testing additional candidate values and observing the outputs of the modulo operations. For example, if the distributions of the modulo operations produce an even distribution of values, the search can test smaller candidate values. If the distribution presents according to one of the other patterns, fractions and/or multiples of the initial test value can be tested too. For example, if the distribution of the IET modulo frequency spreads over two extremes, the IET estimate can be translated by t such that the distribution of (IET+t) modulo the frequency period spreads over one area only. The algorithm can then be applied to the new distribution.

Based on the above estimations, the systems and methods described herein can recommend a feature job frequency period based on the best estimate of the data source refresh frequency as determined by the iterative estimation. Multiples of the frequency period can also be suggested if users would prefer to reduce the frequency of feature jobs, e.g., to save on computational resources.

Based on determining the recommendation of the feature job frequency period, the feature job orchestration module may determine a timeliness of updates to event data from the event data's data source. The feature job orchestration module may determine one or more late updates to event data from the event data's data source. For the event data including and/or excluding the late updates, the feature orchestration module may determine a recommended timestamp at and/or before which to aggregate event data used to execute a feature job during a feature job frequency period. A recommended timestamp at which to aggregate event data used to execute a feature job during a frequency period of the feature job may be based on a last estimated timestamp at which event data is updated during the feature job frequency period and a buffer period.

Based on the combination of the last estimated timestamp and the buffer period, the feature job orchestration module may evaluate one or more blind spots and select one recommended blind spot from the one or more blind spots. Blind spot candidates can be selected to determine cutoffs for feature aggregation windows, thereby allowing the systems and methods described herein to account for data that is not recorded in a data warehouse, database, or other data storage in a timely fashion for processing. For each blind spot, a matrix can be computed that includes tiles of event timestamps as rows, and time that goes up to the largest interval between observed event timestamps and record timestamps as columns. The size of a tile in the matrix can be equal to the feature job frequency period, and tile endpoints can be set as a function of the recommended feature job time and the blind spot candidate.

The matrix values can be equal to the number of events related to the row tile recorded before a timestamp equal to the tile endpoint plus the time defined by the column. Recent event timestamps can be excluded from this calculation to ensure that the matrix is complete. The sum of each column in the matrix provides the average record development of event tiles, and can based on these average records, a percentage of late data can be estimated. Recommended blind spots can provide a percentage of late data that is nearest to a user-defined tolerance, such as 0.005%.

The term “blind spot” as used herein refers to a cutoff window after which data is considered “late” and is not included in estimation calculations. For example, a blind spot of 100 seconds can mean that data landing in the database or data warehouse after 100 seconds from the start of a feature aggregation window will not be included in the aggregation. Candidate blind spots can have an associated “landing” percentage, i.e., a percentage of data landing at the database or data warehouse within a job interval that is included in the aggregation. For example, a set of candidate blind spots can be 70, 80, 90, and 100 seconds, with corresponding “landing rates” of 99.5%, 99.9%, 99.99%, and 100%. The recommended blind spot can be selected based on the landing rates and a user-defined tolerance. In this example, if a user defines a tolerance of 0.01% of events being defined as late, then the recommended blind spot will be 90 seconds. If the user defines a tolerance of 0.1%, then the recommended blind spot will be 80 seconds. Once a blind spot is recommended, users can back test the blind spot on historical data from previous feature job schedules to determine if the blind spot recommendation applies to actual data collected.

In some cases, the blind spot may be described with respect to a start timestamp of the feature job frequency period. The feature job orchestration module may select the recommended blind spot based on analysis of event timestamps corresponding to event data and the record creation timestamps corresponding to event data. Based on the selected blind spot, the feature job orchestration module may provide a recommended feature job frequency period, a recommended timestamp at and/or before which to aggregate event data used to execute a feature job during a feature job frequency period, and a blind spot for materializing feature(s) derived from the event data. The recommended feature job scheduling for the feature(s) may be automatically applied for the feature(s) and may be indicated by metadata of the feature(s) as described herein. Feature job scheduling automatically applied for features may be modified.

In some embodiments, data warehouse job failures can result in recommendations of unnecessarily long blind spots. For this reason, the systems and methods described herein can include job-failure detection and provide an analysis both with and without the impact of job failures. Job failure detection can be based on an analysis of the age of records recorded after scheduled jobs for which no new records have been added during their expected update period. If the distribution of the age of the records is similar to the distribution of the age of the records normally observed, the missing jobs can be assumed to be missing due to a lack of data. If the distribution appears anomalous, the missing job can be assumed to be a job failure. Discarding failed jobs from blind spot calculations can ensure that blind spots of an appropriate length are recommended.

### Exemplary Techniques for Automated Annotation of Feature Signal Types

In some embodiments, as described herein, the feature catalog module may automatically tag each generated feature with a respective theme and included signal type. The feature catalog module may automatically determine and assign a signal type for each feature based on one or more heuristic techniques. A signal type may be automatically determined and assigned to a feature based on the feature's lineage and the ontology of source data used to materialize the feature. Examples of signal types can include frequency, recency, monetary, diversity, inventory, location, similarity, stability, timing, statistic, and attribute signal types. A feature's lineage may include first computer code (e.g., SDK code) that can be used to declare a version of a feature and second computer code (e.g., SQL code) that can be used to compute a value for the version of the feature from source data stored by the data warehouse.

In some embodiments, the feature catalog module may perform one or more heuristic techniques to determine a signal type of a feature. To determine whether a feature has a similarity signal type, the feature catalog module may determine whether the feature is derived from a lookup feature (e.g., lookup feature without aggregation) and time window aggregate features. When the feature is derived from a lookup feature and time window aggregate features, the feature catalog may assign a similarity signal type to the feature. Examples of features with a similarity signal type include (1) a ratio of a current transaction amount to a maximum amount of a customer's transaction over the past 7 days; and (2) a cosine similarity of a current basket to customer baskets over the past 7 days.

In some cases, the feature catalog module may determine whether a feature is derived from a lookup feature or an aggregation operation that is not a time window aggregate operation. Based on determining a feature is derived from a lookup feature or an aggregation operation that is not a time window aggregate operation, the feature catalog module may perform one or more determinations. The feature catalog module may determine whether one input column of the feature has a semantic association with a monetary signal type. When the feature catalog module determines one input column of the feature has a semantic association with a monetary signal type, the feature catalog module may assign a monetary signal type to the feature. The feature catalog module may determine whether one input column of the feature has a semantic association with location. When the feature catalog module determines one input column of the feature has a semantic association with location, the feature catalog module may assign a location signal type to the feature.

The feature catalog module may determine whether the feature is a lookup feature derived from a slowly changing data and includes a time offset. When the feature catalog module determines the feature is a lookup feature derived from a slowly changing data and includes a time offset, the feature catalog module may assign a past attribute signal type to the feature. The feature catalog module may determine whether the feature is a lookup feature with no time offset. When the feature catalog module determines the feature is a lookup feature with no time offset, the feature catalog module may assign an attribute signal type to the feature. When feature catalog module determines a feature is derived from a lookup feature or an aggregation operation that is not time window aggregate operation and the feature is not any of a monetary, location, past attribute, or attribute signal type, the feature catalog module may assign a default feature such as a statistics signal type to the feature.

In some cases, the feature catalog module may determine whether a feature is derived from multiple aggregations and multiple windows. When the feature catalog module determines the feature is derived from multiple aggregations and multiple windows, the feature catalog module may assign a stability signal type to the feature. The feature catalog module may determine whether a feature is derived from multiple aggregations using different group keys. When the feature catalog module determines the feature is derived from multiple aggregations using different group keys, the feature catalog module may assign a similarity signal type to the feature.

The feature catalog module may determine whether a feature is derived from an aggregation function using a “last” operation. When the feature catalog module determines the feature is derived from an aggregation function using a “last” operation, the feature catalog module may assign a recency signal type to the feature.

The feature catalog module may determine whether one input column of a feature is an event timestamp. When the feature catalog module determines one input column of a feature is an event timestamp, the feature catalog module may assign a timing signal type to the feature. The feature catalog module may determine whether one input column of the feature has a semantic association with location. When the feature catalog module determines one input column of the feature has a semantic association with location, the feature catalog module may assign a location signal type to the feature.

In some embodiments, the feature catalog module may determine whether the feature is derived from an aggregation per category and an entropy transformation. When the feature catalog module determines the feature is derived from an aggregation per category and an entropy transformation, the feature catalog module may assign a diversity signal type to the feature. The feature catalog module may determine whether the feature is derived from an aggregation per category and an entropy transformation was not used after the aggregation.

When the feature catalog module determines the feature is derived from an aggregation per category and an entropy transformation was not used after the aggregation, the feature catalog module may assign an inventory signal type to the feature. The feature catalog module may determine whether one input column of the feature has a semantic association with monetary. When the feature catalog module determines one input column of the feature has a semantic association with monetary, the feature catalog module may assign a monetary signal type to the feature.

In some embodiments, the feature catalog module may determine whether a feature is (or is derived from) a cross-aggregate feature. In general, an aggregate feature may be derived by applying an aggregation operation to a set of data objects related to an entity (e.g., values of a column in a table). Some non-limiting examples of aggregation operations may include the latest operation (which retrieves the most recent value in the column), the count operation (which tallies the number of data values in a column), the NA count operation (which tallies the number of missing data values in the column), and the sum, minimum, maximum, and standard deviation operations (which calculate the sum, minimum value, maximum value, and standard deviation of the values in the column). Likewise, a “cross-aggregate feature” may be derived by aggregating data objects related to an entity across two or more categories. For example, a cross-aggregate feature could be the amount a customer spends in each of K product categories over a certain period. Here, the ‘customer’ is the entity and the ‘product category’ is the categorical variable. Thus, the aggregation is performed across different product categories for each customer. Such a feature reveals spending patterns or preferences, providing insights into customer behavior across diverse product categories. When the feature catalog module determines the feature is (or is derived from) a cross-aggregate feature, the feature catalog module may assign a “bucketing” signal type to the feature. Here, “bucketing” refers to aggregating data not just by a single entity, but also two or more categories (buckets) related to the entity.

In some embodiments, the feature catalog module may determine whether a feature is derived from a time window aggregation and uses a “count” operation. When the feature catalog module determines the feature is derived from a time window aggregation and uses a “count” operation, the feature catalog module may assign a frequency signal type to the feature. The feature catalog module may determine whether a feature is derived from a time window aggregation and uses a “count” operation. When the feature catalog module determines the feature is derived from a time window aggregation and uses a “standard deviation” operation, the feature catalog module may assign a diversity signal type to the feature. When the feature catalog module fails to assign a signal type to a feature based on one of the above described techniques, the feature catalog module may assign a stats signal type to the feature. In some cases, alternative or additional techniques may be used by the feature catalog module to automatically determine and assign a feature's signal type.

FIG. 3 is a flow diagram of an example method 300 for automatically determining a signal type of a feature, in accordance with some embodiments. The method 300 may be performed, for example, by the feature engineering control platform 100. The method 300 may include steps 302-306.

In step 302, the platform populates a feature catalog. Populating the feature catalog may include generating a plurality of features based on source data. The source data may be registered from one or more data sources. Generating each feature may include applying one or more data transformations associated with the feature to a respective subset of the source data. In some embodiments, generating each feature further includes selecting the one or more data transformations associated with the feature based on data indicating semantic types of one or more data fields of the respective subset of the source data corresponding to the feature.

In step 304, for each of one or more features in the feature catalog, a signal type of the feature is determined. The signal type (or types) of a feature may be determined based on data indicating (1) the semantic types of one or more fields of the source data used to generate the feature and/or (2) the one or more data transformations associated with the feature. The semantic types of the one or more fields may be selected from a plurality of semantic types defined by a data ontology.

In step 306, the platform associates the features with their determined signal types in the feature catalog.

In some embodiments, the method 300 further includes receiving query data identifying a signal type; identifying one or more features in the feature catalog having the signal type identified in the query data; and providing the identified features. In some embodiments, the identified features are provided to a device configured to train or use a model to make predictions based on the observation data set.

In some embodiments, the plurality of features is a plurality of first features, and populating the feature catalog further includes generating a plurality of second features based on the plurality of first features. Generating each second feature may include applying one or more data transformations associated with the second feature to one or more of the first features. In some embodiments, generating each second feature includes applying one or more data transformations associated with the second feature to one or more first features and to a respective subset of the source data. In some embodiments, the method further includes, for each second feature, determining one or more signal types of the second feature based at least in part on data indicating signal types of one or more first features used to generate the second feature and the one or more data transformations associated with the second feature; and associating the second feature with the one or more signal types of the second feature in the feature catalog.

### Exemplary Techniques for Automated Feature Discovery

In some embodiments, as described herein, the feature discovery module of the platform provider control plane may enable users to perform automated feature discovery for features that may be materialized and served by the feature engineering control platform. Semantic labels assigned to data objects (e.g., tables, columns of tables, etc.) by the data annotation and observability module may indicate the nature of the tables and/or their data fields. The declarative framework module as described herein may enable users to creatively manipulate tables to generate features and use cases. A feature store module may enable users to reuse generated features and push new generated features into production for serving (e.g., serving to artificial intelligence models). Based on the functionality of the data annotation and observability module and declarative framework module, the feature discovery module may perform automated feature discovery using a feature discovery algorithm.

In some embodiments, using the feature discovery module, users may initiate automated feature discovery by the feature discovery module by providing an input. The input may be (1) a use case or (2) a view and an entity (or a tuple of entities). For a received input use case, the feature discovery module may first identify the entity relationships of the use case entities. Based on the identified entity relationships of the use case entities, the feature discovery module may identify all entities associated with the use case (including parent entities and subtype entities of the use case entities) and identify a data model corresponding to the use case that indicates all tables that can be used to generate features for the entities. Based on identifying the entities and the data model, the feature discovery module may execute, for each entity and each view of the source data included in the data model, the feature discovery algorithm. When the use case is defined by a tuple of entities, the feature discovery module may execute the feature discovery algorithm for the tuple of entities. For each respective combination of an entity and view (e.g., associated with the use case and/or or received as an input), the feature discovery module may apply one or more data transformations to the view. The one or more data transformations applied to a view may be selected based on the semantics of data fields included in the view and/or the data type (e.g., event, time-series, item, slowly changing dimension, or dimension) of the view. The one or more data transformations may include joining one or more other views to the view based on the entity. Based on the one or more data transformations applied to the view (or view column), the feature discovery module may provide one or more feature recipes for display at the graphical user interface that are derived from the view (or view column) and the entity.

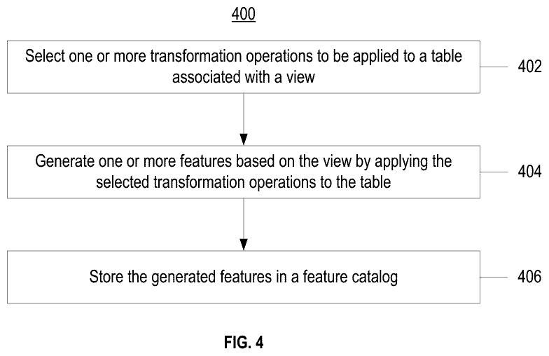

FIG. 4 is a flow diagram of an example method 400 for automated feature discovery, in accordance with some embodiments. The method 400 may be performed, for example, by the feature engineering control platform 100. The automated feature discovery may be performed with respect to a first entity and a view. In some embodiments, user input identifying a use case is received, and the first entity and the view are identified based on the use case. In some embodiments, user input identifies the first entity and the view. The view may be associated with a table derived from source data. The table may include columns. Each column of the table may represent a data field having an assigned semantic type. Performing the automated feature discovery may include steps 402-406.

In step 402, one or more transformation operations to be applied to the table are selected. The transformation operations may be selected based on a data type of the view, an entity type of the first entity, entity types of one or more second entities related to the first entity, one or more entity relationships between the first entity and the one or more second entities, one or more descriptive statistics characterizing values in one or more columns of the table, and/or a semantic type assigned to a column of the table, etc.

In step 404, one or more features are generated based on the view. Generating the one or more features may include applying the one or more selected transformation operations to the table.

In step 406, the generated features are stored in a feature catalog.

In some embodiments, the method 400 further includes providing the generated features to a device configured to train or use a model to make predictions based on the generated features.

In some embodiments, the features are first features, the transformation operations are first transformation operations, and the method further includes generating a second feature based on the first features. Generating the second feature may include applying one or more second transformation operations to the one or more first features. In some embodiments, generating the second feature further includes selecting the second transformation operations based on attributes of the first features. In some embodiments, the second transformation operations are selected based on signal types of the first features. In some embodiments, the second transformation operations are selected based on feature lineages of the first features. In some embodiments, the second transformation operations are selected based on data types of the first features.

In some embodiments, the method 400 further includes obtaining the descriptive statistics characterizing the values in a particular column of the table. The descriptive statistics may include, for example, a unique count of values in the particular column, a percentage of rows of the table in which a value of the particular column is missing, a minimum value in the particular column, and/or a maximum value in the particular column.

In some embodiments, each semantic type assigned to a column of the table is selected from an ontology of types. In some embodiments, applying the selected transformation operations to the table includes joining the table with one or more other tables.

### Exemplary Techniques for Generating an Execution Graph

In some embodiments, as described herein, the execution graph module may enable generation of one or more execution graphs. An execution graph may capture a series of non-ambiguous data manipulation actions to be applied to source data (e.g., tables). An execution graph may be representative of the steps performed to generate a view, column, feature, and/or a group of features from one or more tables. An execution graph may capture and store data manipulation operations that can be applied to the tables, such that the execution graph may be converted to platform-specific instructions (e.g., platform-specific SQL instructions) for feature and/or view materialization when needed (e.g., based on receiving a feature request). An execution graph may include a number of nodes and a number of edges, where edges may connect the nodes and may represent input and output relationships between the nodes. A node may indicate a particular operation (e.g., data manipulation and/or transformation) applied to input data (e.g., input source data or transformed source data). An edge connected between a first node and a second node may indicate that an output from a first node is provided as an input to a second node. Source data and/or transformed source data may be provided as an input to an execution graph. A view or feature may be an output of an execution graph.

In some embodiments, an execution graph may be generated from intended data transformation operations by a data manipulation API. The data manipulation API may be implemented in a computer programming language such as Python. Implementation of the data manipulation API in Python may enable codification of data manipulation steps such as column transformations, row filtering, projections, joins, and aggregations without the use of graph primitives.

In some embodiments, an execution graph may include metadata to support extensive validation of generated features and/or views and to infer output metadata for the generated features and/or views. Metadata included in an execution graph can include data metadata. Data metadata can include a data type for input source data provided as an input to the execution graph used to generate the feature(s) and/or view(s) and an indication of the column(s) from the input source data. Metadata included in an execution graph can include column metadata. Column metadata can include a data type, entity, data semantic, and/or cleaning steps for a column and/or columns corresponding to the column metadata. Metadata included in an execution graph can include node metadata. Node metadata can include arbitrary tagging applied to a node, which may be indicative of an operation corresponding to the node such as “cleaning”, “transformation”, or “feature.” Metadata included in an execution graph can include subgraph metadata. Subgraph metadata may include arbitrary tagging applied to a subgraph included in the execution graph.

In some embodiments, as described herein, a value of a feature may be dependent on an additional input (e.g., an observation set) that may be unavailable prior to the time of materialization of the feature. A feature may be partially computed and cached as tiles (e.g., as described with respect to the feature store module). An execution graph may support creation of SQL for computing one or more of: feature values without using tiles, feature values using tiles, and tile values.

In some embodiments, each node included in an execution graph may represent an operation on an input to the respective node. A node's edges may represent input and output relationships between nodes. A subgraph of an execution graph may include a starting node and may include all nodes connected to the starting node from the input edges of the starting node. A proper subgraph of an execution graph may be a subgraph that represents each of the steps performed to generate a view or a group of features from input data provided to the subgraph. In some cases, a subgraph can be pruned to reduce the complexity of the subgraph without changing the output of the subgraph. Some examples of pruning steps that can be applied to a subgraph of an execution graph can include excluding unnecessary columns in projections, removing redundant nodes, removing redundant parameters in nodes. Pruning may simplify an execution graph's representation of operations and reduce computation and storage costs for the execution graph.

In some embodiments, the execution graph module may support nesting of subgraphs, where a subgraph of an execution graph can be included as a node in another execution graph. Nesting can facilitate the representation of a group of operations as a single operation to facilitate reuse of the group of operations and improve readability of an execution graph. Examples of such operations can include data cleaning steps and multi-step transformations.

### Some Embodiments

Some embodiments are described in the following numbered paragraphs.

(A1) A computer-implemented method, the method comprising: receiving an indication of a context and an indication of an observation time period; generating a sample set of entity instances associated with the context and the observation time period, wherein generating the sample set includes: selecting a first subset of entity instances from a plurality of entity instances, each entity instance in the first subset of entity instances being associated with the context and with one or more timestamps that intersect the observation time period; and selecting a second subset of entity instances from the first subset of entity instances based on the one or more timestamps associated with the first subset of entity instances, wherein the second subset of entity instances is the sample set of entity instances; generating an observation data set associated with the context and the observation time period based on the sample set of entity instances; and providing the observation data set to a device configured to train or use a model to make predictions based on the observation data set.

(A2) The method of A1, wherein the sample set of entity instances includes values of one or more features.

(A3) The method of A2, further comprising analyzing the one or more features, wherein analyzing the one or more features comprises performing statistical analysis of the values of the one or more features.

(A4) The method of A3, wherein generating the observation data set includes selecting at least one feature from the one or more features of the sample set of entity instances and adding the at least one selected feature to the observation data set.

(A5) The method of A4, wherein the selecting of the at least one feature is based on the statistical analysis of the values of the one or more features.

(A6) The method of A2, wherein a respective signal type has been automatically assigned to each feature included in the one or more features.

(A7) The method of A1, wherein selecting the second subset of entity instances from the first subset of entity instances comprises: identifying an entity instance in the first subset of entity instances having a start timestamp earlier than a start time of the observation time period and an end timestamp within the observation time period; generating a clipped entity comprising entity data of the entity instance between the start time of the observation time period and the end timestamp of the entity; and including the clipped entity in the second subset of entity instances.

(A8) The method of A1, wherein the indication of the context identifies an event entity, and wherein the plurality of entity instances comprises a plurality of event entity instances corresponding to the event entity.

(A9) The method of A8, wherein selecting the second subset of entity instances from the first subset of entity instances comprises, for each entity instance in the first subset of entity instances, probabilistically adding the entity instance to the second subset of entity instances based on a selection probability associated with the entity instance.

(A10) The method of A9, wherein the selection probability associated with the entity instance is based on the one or more timestamps associated with the entity instance.

(A11) The method of A10, wherein the one or more timestamps associated with the entity instance include a start timestamp and an end timestamp, and wherein the selection probability associated with the entity instance depends on a difference between the end timestamp and the start timestamp.

(A12) The method of A11, wherein the plurality of event entity instances correspond to a plurality of event durations, wherein each event duration of the plurality of event durations is equal to a difference between the end timestamp and the start timestamp of the corresponding event entity instance, and wherein the method further comprises determining a maximum event duration among the plurality of event durations.

(A13) The method of A12, wherein the selection probability associated with the entity instance is based on a ratio between the event duration corresponding to the entity distance and the maximum event duration.

(A14) The method of A1, wherein the indication of the context identifies a particular entity other than an event entity, and wherein the plurality of entity instances correspond to the particular entity.

(A15) The method of A14, wherein selecting the second subset of entity instances from the first subset of entity instances comprising sampling the first subset of entity instances, wherein a minimum sampling interval is enforced when sampling the first subset of entity instances.

(A16) The method of A15, wherein the indication of the context identifies a target object and an inference period associated with the target object, and wherein the method further comprises adjusting a value of the minimum sampling interval such that the adjusted value of the minimum sampling interval is greater than the inference period.

(A17) The method of A16, further comprising adjusting a value of the minimum sampling interval such that the adjusted value of the minimum sampling interval is not an integer multiple of one hour.

(A18) The method of A15, wherein selecting the second subset of entity instances from the first subset of entity instances comprises, for each entity instance in the first subset of entity instances: (a) randomly selecting a point-in-time from a time period beginning at a start time of the observation time period and having a duration matching the minimum sampling interval; (b) adding the entity instance to the second subset of entity instances if the point in time is less than or equal to an end time of the observation time period and less than or equal to an end timestamp of the entity instance; (c) increasing the point-in-time by the minimum sampling interval; and (d) repeating steps (b)-(d) until the point-in-time is greater than end time of the observation time period or greater than the end timestamp of the entity instance.

(A19) An apparatus comprising at least one processor; and at least one computer-readable storage medium having encoded thereon executable instructions that, when executed by the at least one processor, cause the at least one processor to perform operations including: receiving an indication of a context and an indication of an observation time period; generating a sample set of entity instances associated with the context and the observation time period, wherein generating the sample set includes: selecting a first subset of entity instances from a plurality of entity instances, each entity instance in the first subset of entity instances being associated with the context and with one or more timestamps that intersect the observation time period; and selecting a second subset of entity instances from the first subset of entity instances based on the one or more timestamps associated with the first subset of entity instances, wherein the second subset of entity instances is the sample set of entity instances; generating an observation data set associated with the context and the observation time period based on the sample set of entity instances; and providing the observation data set to a device configured to train or use a model to make predictions based on the observation data set.

(A20) At least one computer-readable storage medium encoded with computer-executable instructions that, when executed by a computer, cause the computer to perform operations including: receiving an indication of a context and an indication of an observation time period; generating a sample set of entity instances associated with the context and the observation time period, wherein generating the sample set includes: selecting a first subset of entity instances from a plurality of entity instances, each entity instance in the first subset of entity instances being associated with the context and with one or more timestamps that intersect the observation time period; and selecting a second subset of entity instances from the first subset of entity instances based on the one or more timestamps associated with the first subset of entity instances, wherein the second subset of entity instances is the sample set of entity instances; generating an observation data set associated with the context and the observation time period based on the sample set of entity instances; and providing the observation data set to a device configured to train or use a model to make predictions based on the observation data set.

(B1) A computer-implemented method comprising registering source data from a plurality of data sources; populating a feature catalog, wherein populating the feature catalog includes generating a plurality of features based on the source data, wherein generating each feature in the plurality of features comprises applying one or more data transformations associated with the feature to a respective subset of the source data; and for each feature in the feature catalog: determining one or more signal types of the feature based at least in part on data indicating semantic types of one or more fields of the source data used to generate the feature and the one or more data transformations associated with the feature, wherein the semantic types of the one or more fields are selected from a plurality of semantic types defined by a data ontology; and associating the feature with the one or more signal types in the feature catalog.

(B2) The method of B1, wherein generating each feature in the plurality of features further comprises selecting the one or more data transformations associated with the feature based on data indicating semantic types of one or more data fields of the respective subset of the source data corresponding to the feature.

(B3) The method of B1, further comprising receiving query data identifying a signal type; identifying one or more features in the feature catalog having the signal type identified in the query data; and providing the identified one or more features.

(B4) The method of B3, wherein providing the identified one or more features comprises providing the identified one or more features to a device configured to train or use a model to make predictions based on the observation data set.

(B5) The method of B1, wherein the plurality of features is a plurality of first features, and wherein populating the feature catalog further includes generating a plurality of second features based on the plurality of first features, wherein generating each second feature in the plurality of second features comprises applying one or more data transformations associated with the second feature to one or more first features of the first plurality of features.

(B6) The method of B5, wherein generating each second feature comprises applying one or more data transformations associated with the second feature to one or more first features and to a respective subset of the source data.

(B7) The method of B5, further comprising, for each second feature in the second plurality of features: determining one or more signal types of the second feature based at least in part on data indicating signal types of one or more first features used to generate the second feature and the one or more data transformations associated with the second feature; and associating the second feature with the one or more signal types of the second feature in the feature catalog.

(B8) The method of B7, wherein determining the one or more signal types of the second feature comprises determining that at least one signal type of the second feature is a similarity signal type based at least in part on lineage data indicating that the second feature is derived from a lookup feature and a time window aggregate feature.

(B9) The method of B7, wherein determining the one or more signal types of the second feature comprises determining that the second feature has an attribute signal type based on data indicating that the second feature is derived from a first feature having a lookup feature signal type and no time offset.

(B10) The method of B7, wherein determining the one or more signal types of the second feature comprises determining that the second feature has a stability signal type based at least in part on data indicating that the second feature is derived from a plurality of time windows.

(B11) The method of B1, wherein determining the one or more signal types of the feature comprises determining that the feature comprises a particular signal type based at least in part on determining that at least one input of the feature has a semantic association with the particular signal type.

(B12) The method of B1, wherein the one or more signal types of the feature comprises a monetary signal type and/or a location signal type.

(B13) The method of B1, wherein determining the one or more signal types of the feature comprises determining that the feature has a past attribute signal type based at least in part on data indicating that the feature is derived from slowly changing data and includes a time offset.

(B14) The method of B1, wherein determining the one or more signal types of the feature comprises determining that the feature has a bucketing signal type based at least in part on data indicating that deriving the feature includes: selecting a subset of values from a column of values in a table corresponding to an entity based on the subset of values sharing a categorical attribute, and performing an aggregation operation on the selected subset of values.

(B15) An apparatus comprising at least one processor; and at least one computer-readable storage medium having encoded thereon executable instructions that, when executed by the at least one processor, cause the at least one processor to perform operations including registering source data from a plurality of data sources; populating a feature catalog, wherein populating the feature catalog includes generating a plurality of features based on the source data, wherein generating each feature in the plurality of features comprises applying one or more data transformations associated with the feature to a respective subset of the source data; and for each feature in the feature catalog: determining one or more signal types of the feature based at least in part on data indicating semantic types of one or more fields of the source data used to generate the feature and the one or more data transformations associated with the feature, wherein the semantic types of the one or more fields are selected from a plurality of semantic types defined by a data ontology; and associating the feature with the one or more signal types in the feature catalog.

(B16) At least one computer-readable storage medium encoded with computer-executable instructions that, when executed by a computer, cause the computer to perform operations including registering source data from a plurality of data sources; populating a feature catalog, wherein populating the feature catalog includes generating a plurality of features based on the source data, wherein generating each feature in the plurality of features comprises applying one or more data transformations associated with the feature to a respective subset of the source data; and for each feature in the feature catalog: determining one or more signal types of the feature based at least in part on data indicating semantic types of one or more fields of the source data used to generate the feature and the one or more data transformations associated with the feature, wherein the semantic types of the one or more fields are selected from a plurality of semantic types defined by a data ontology; and associating the feature with the one or more signal types in the feature catalog.

(C1) A computer-implemented method comprising performing automated feature discovery with respect to a first entity and a view, wherein the view is associated with a table derived from source data, wherein the table includes a plurality of columns, wherein each column of the table represents a data field having an assigned semantic type, and wherein performing the automated feature discovery includes selecting one or more transformation operations to be applied to the table based on a data type of the view, an entity type of the first entity, entity types of one or more second entities related to the first entity, one or more entity relationships between the first entity and the one or more second entities, one or more descriptive statistics characterizing values in one or more columns of the table, and/or a semantic type assigned to a column of the table; generating one or more features based on the view, wherein generating the one or more features comprises applying the one or more selected transformation operations to the table; and storing the one or more generated features in a feature catalog.

(C2) The method of C1, wherein selecting the one or more transformation operations comprises selecting a particular transformation operation to be applied to the table based on the data type of the view.

(C3) The method of C1, wherein selecting the one or more transformation operations comprises selecting a particular transformation operation to be applied to the table based on the entity type of the first entity.

(C4) The method of C1, wherein selecting the one or more transformation operations comprises selecting a particular transformation operation to be applied to the table based on the entity types of the one or more second entities related to the first entity.

(C5) The method of C1, wherein selecting the one or more transformation operations comprises selecting a particular transformation operation to be applied to the table based on the or more entity relationships between the first entity and the one or more second entities.

(C6) The method of C1, wherein selecting the one or more transformation operations comprises selecting a particular transformation operation to be applied to the table based on the semantic type assigned to a column of the table.

(C7) The method of C1, further comprising providing the one or more generated features to a device configured to train or use a model to make predictions based on the one or more generated features.

(C8) The method of C1, wherein the one or more features comprise one or more first features, wherein the one or more transformation operations comprises one or more first transformation operations, and wherein the method further comprises: generating a second feature based on the one or more first features, wherein generating the second feature comprises applying one or more second transformation operations to the one or more first features.

(C9) The method of C8, wherein generating the second feature further comprises selecting the one or more second transformation operations based on one or more attributes of the one or more first features.

(C10) The method of C9, wherein the one or more second transformation operations are selected based on signal types of the one or more first features.

(C11) The method of C10, wherein the one or more first features include a first feature having a bucketing signal type, wherein the one or more second transformation operations are selected based on the first feature having the bucketing signal type, and wherein the one or more second operations are applied to first feature having the bucketing signal type.

(C12) The method of C11, wherein the one or more second transformation operations include an entropy operation, a unique count operation, a most frequent operation, a relative frequency operation, and/or a rank operation.

(C13) The method of C9, wherein the one or more second transformation operations are selected based on feature lineages of the one or more first features.

(C14) The method of C13, wherein the one or more first features include a first feature and a second feature, the first feature having a first feature lineage including a plurality of attributes and a first aggregation attribute, and the second feature having a second feature lineage including the plurality of attributes and a second aggregation attribute, wherein the one or more second transformation operations are selected based on the first aggregation attribute differing from the second aggregation attribute.

(C15) The method of C14, wherein the first aggregation attribute is a first aggregation window and the second aggregation attribute is a second aggregation window, wherein the one or more second transformation operations include a comparison operation, and wherein a signal type of the second feature includes a stability signal type.

(C16) The method of C14, wherein the first aggregation attribute is a first aggregation grouping key and the second aggregation attribute is a second aggregation grouping key, wherein the one or more second transformation operations include a comparison operation, and wherein a signal type of the second feature includes a similarity signal type.

(C17) The method of C13, wherein the one or more first features include a lookup feature derived from a column of a view and an aggregate feature having a feature lineage including an aggregation column equal to the column of the view, wherein the one or more second transformation operations are selected based on the feature lineage of the aggregate feature, and wherein a signal type of the second feature includes a similarity signal type.

(C18) The method of C9, wherein the one or more second transformation operations are selected based on data types of the one or more first features.

(C19) The method of C18, wherein the one or more first features include a first feature having a datetime data type, wherein the one or more second transformation operations are selected based on the first feature having the datetime data type, wherein the one or more second operations are applied to first feature having the datetime data type, and wherein a signal type of the second feature includes a recency signal type.

(C20) The method of C1, further comprising obtaining the descriptive statistics characterizing the values in a particular column of the table, wherein the descriptive statistics include a unique count of values in the particular column, a percentage of rows of the table in which a value of the particular column is missing, a minimum value in the particular column, and/or a maximum value in the particular column.

(C21) The method of C1, wherein each semantic type assigned to a column of the table is selected from an ontology of types.

(C22) The method of C1, wherein applying the one or more selected transformation operations to the table comprises joining the table with one or more other tables.

(C23) The method of C1, further comprising receiving user input identifying the first entity and the view.

(C24) The method of C1, further comprising receiving user input identifying a use case; and identifying the first entity and the view based on the use case.

(C25) An apparatus comprising at least one processor; and at least one computer-readable storage medium having encoded thereon executable instructions that, when executed by the at least one processor, cause the at least one processor to perform operations including: performing automated feature discovery with respect to a first entity and a view, wherein the view is associated with a table derived from source data, wherein the table includes a plurality of columns, wherein each column of the table represents a data field having an assigned semantic type, and wherein performing the automated feature discovery includes selecting one or more transformation operations to be applied to the table based on a data type of the view, an entity type of the first entity, entity types of one or more second entities related to the first entity, one or more entity relationships between the first entity and the one or more second entities, one or more descriptive statistics characterizing values in one or more columns of the table, and/or a semantic type assigned to a column of the table; generating one or more features based on the view, wherein generating the one or more features comprises applying the one or more selected transformation operations to the table; and storing the one or more generated features in a feature catalog.

(C26) At least one computer-readable storage medium encoded with computer-executable instructions that, when executed by a computer, cause the computer to perform operations including performing automated feature discovery with respect to a first entity and a view, wherein the view is associated with a table derived from source data, wherein the table includes a plurality of columns, wherein each column of the table represents a data field having an assigned semantic type, and wherein performing the automated feature discovery includes selecting one or more transformation operations to be applied to the table based on a data type of the view, an entity type of the first entity, entity types of one or more second entities related to the first entity, one or more entity relationships between the first entity and the one or more second entities, one or more descriptive statistics characterizing values in one or more columns of the table, and/or a semantic type assigned to a column of the table; generating one or more features based on the view, wherein generating the one or more features comprises applying the one or more selected transformation operations to the table; and storing the one or more generated features in a feature catalog.

### Some Examples of Computing Devices

In embodiments, aspects of the techniques described herein (e.g., timing the emission of the transmitted signal, processing received return signals, and so forth) may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), network storage device, or any other suitable device and may vary in size, shape, performance, functionality, and price.

FIG. 5 is a block diagram of an example computer system 500 that may be used in implementing the technology described in this document. General-purpose computers, network appliances, mobile devices, or other electronic systems may also include at least portions of the system 500. The system 500 includes a processor 510, a memory 520, a storage device 530, and an input/output device 540. Each of the components 510, 520, 530, and 540 may be interconnected, for example, using a system bus 550. The processor 510 is capable of processing instructions for execution within the system 500. In some implementations, the processor 510 is a single-threaded processor. In some implementations, the processor 510 is a multi-threaded processor. In some implementations, the processor 510 is a programmable (or reprogrammable) general purpose microprocessor or microcontroller. The processor 510 is capable of processing instructions stored in the memory 520 or on the storage device 530.

The memory 520 stores information within the system 500. In some implementations, the memory 520 is a non-transitory computer-readable medium. In some implementations, the memory 520 is a volatile memory unit. In some implementations, the memory 520 is a nonvolatile memory unit.

The storage device 530 is capable of providing mass storage for the system 500. In some implementations, the storage device 530 is a non-transitory computer-readable medium. In various different implementations, the storage device 530 may include, for example, a hard disk device, an optical disk device, a solid-date drive, a flash drive, or some other large capacity storage device. For example, the storage device may store long-term data (e.g., database data, file system data, etc.). The input/output device 540 provides input/output operations for the system 500. In some implementations, the input/output device 540 may include one or more network interface devices, e.g., an Ethernet card, a serial communication device, e.g., an RS-232 port, and/or a wireless interface device, e.g., an 802.11 card, or a 3G, 4G, or 5G wireless modem. In some implementations, the input/output device may include driver devices configured to receive input data and send output data to other input/output devices, e.g., keyboard, printer and display devices 560. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 530 may be implemented in a distributed way over a network, for example as a server farm or a set of widely distributed servers or may be implemented in a single computing device.

Although an example processing system has been described in FIG. 11, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, a data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array), an ASIC (application specific integrated circuit), or a programmable general purpose microprocessor or microcontroller. A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA, an ASIC, or a programmable general purpose microprocessor or microcontroller.

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic disks, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

### Terminology

The phrasing and terminology used herein is for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method comprising:
performing automated feature discovery with respect to a first entity and a view, wherein the view is associated with a table derived from source data, wherein the table includes a plurality of columns, wherein each column of the table represents a data field having an assigned semantic type, and wherein performing the automated feature discovery includes
selecting one or more transformation operations to be applied to the table based on a data type of the view, an entity type of the first entity, entity types of one or more second entities related to the first entity, one or more entity relationships between the first entity and the one or more second entities, one or more descriptive statistics characterizing values in one or more columns of the table, and/or a semantic type assigned to a column of the table;
generating one or more features based on the view, wherein generating the one or more features comprises applying the one or more selected transformation operations to the table; and
storing the one or more generated features in a feature catalog.

2. The method of claim 1, wherein selecting the one or more transformation operations comprises selecting a particular transformation operation to be applied to the table based on the data type of the view.

3. The method of claim 1, wherein selecting the one or more transformation operations comprises selecting a particular transformation operation to be applied to the table based on the entity type of the first entity.

4. The method of claim 1, wherein selecting the one or more transformation operations comprises selecting a particular transformation operation to be applied to the table based on the entity types of the one or more second entities related to the first entity.

5. The method of claim 1, wherein selecting the one or more transformation operations comprises selecting a particular transformation operation to be applied to the table based on the or more entity relationships between the first entity and the one or more second entities.

6. The method of claim 1, wherein selecting the one or more transformation operations comprises selecting a particular transformation operation to be applied to the table based on the semantic type assigned to a column of the table.

7. The method of claim 1, further comprising providing the one or more generated features to a device configured to train or use a model to make predictions based on the one or more generated features.

8. The method of claim 1, wherein the one or more features comprise one or more first features, wherein the one or more transformation operations comprises one or more first transformation operations, and wherein the method further comprises:
generating a second feature based on the one or more first features, wherein generating the second feature comprises applying one or more second transformation operations to the one or more first features.

9. The method of claim 8, wherein generating the second feature further comprises selecting the one or more second transformation operations based on one or more attributes of the one or more first features.

10. The method of claim 9, wherein the one or more second transformation operations are selected based on signal types of the one or more first features.

11. The method of claim 10, wherein the one or more first features include a first feature having a bucketing signal type, wherein the one or more second transformation operations are selected based on the first feature having the bucketing signal type, and wherein the one or more second operations are applied to first feature having the bucketing signal type.

12. The method of claim 11, wherein the one or more second transformation operations include an entropy operation, a unique count operation, a most frequent operation, a relative frequency operation, and/or a rank operation.

13. The method of claim 9, wherein the one or more second transformation operations are selected based on feature lineages of the one or more first features.

14. The method of claim 13, wherein the one or more first features include a first feature and a second feature, the first feature having a first feature lineage including a plurality of attributes and a first aggregation attribute, and the second feature having a second feature lineage including the plurality of attributes and a second aggregation attribute, wherein the one or more second transformation operations are selected based on the first aggregation attribute differing from the second aggregation attribute.

15. The method of claim 14, wherein the first aggregation attribute is a first aggregation window and the second aggregation attribute is a second aggregation window, wherein the one or more second transformation operations include a comparison operation, and wherein a signal type of the second feature includes a stability signal type.

16. The method of claim 14, wherein the first aggregation attribute is a first aggregation grouping key and the second aggregation attribute is a second aggregation grouping key, wherein the one or more second transformation operations include a comparison operation, and wherein a signal type of the second feature includes a similarity signal type.

17. The method of claim 13, wherein the one or more first features include a lookup feature derived from a column of a view and an aggregate feature having a feature lineage including an aggregation column equal to the column of the view, wherein the one or more second transformation operations are selected based on the feature lineage of the aggregate feature, and wherein a signal type of the second feature includes a similarity signal type.

18. The method of claim 9, wherein the one or more second transformation operations are selected based on data types of the one or more first features.

19. The method of claim 18, wherein the one or more first features include a first feature having a datetime data type, wherein the one or more second transformation operations are selected based on the first feature having the datetime data type, wherein the one or more second operations are applied to first feature having the datetime data type, and wherein a signal type of the second feature includes a recency signal type.

20. The method of claim 1, further comprising obtaining the descriptive statistics characterizing the values in a particular column of the table, wherein the descriptive statistics include a unique count of values in the particular column, a percentage of rows of the table in which a value of the particular column is missing, a minimum value in the particular column, and/or a maximum value in the particular column.

21. The method of claim 1, wherein each semantic type assigned to a column of the table is selected from an ontology of types.

22. The method of claim 1, wherein applying the one or more selected transformation operations to the table comprises joining the table with one or more other tables.

23. The method of claim 1, further comprising receiving user input identifying the first entity and the view.

24. The method of claim 1, further comprising:
receiving user input identifying a use case; and
identifying the first entity and the view based on the use case.

25. An apparatus comprising:
at least one processor; and
at least one computer-readable storage medium having encoded thereon executable instructions that, when executed by the at least one processor, cause the at least one processor to perform operations including:
performing automated feature discovery with respect to a first entity and a view, wherein the view is associated with a table derived from source data, wherein the table includes a plurality of columns, wherein each column of the table represents a data field having an assigned semantic type, and wherein performing the automated feature discovery includes
selecting one or more transformation operations to be applied to the table based on a data type of the view, an entity type of the first entity, entity types of one or more second entities related to the first entity, one or more entity relationships between the first entity and the one or more second entities, one or more descriptive statistics characterizing values in one or more columns of the table, and/or a semantic type assigned to a column of the table;
generating one or more features based on the view, wherein generating the one or more features comprises applying the one or more selected transformation operations to the table; and
storing the one or more generated features in a feature catalog.

26. A computer-implemented method, the method comprising:
receiving an indication of a context and an indication of an observation time period;
generating a sample set of entity instances associated with the context and the observation time period, wherein generating the sample set includes:
selecting a first subset of entity instances from a plurality of entity instances, each entity instance in the first subset of entity instances being associated with the context and with one or more timestamps that intersect the observation time period; and
selecting a second subset of entity instances from the first subset of entity instances based on the one or more timestamps associated with the first subset of entity instances, wherein the second subset of entity instances is the sample set of entity instances;
generating an observation data set associated with the context and the observation time period based on the sample set of entity instances; and
providing the observation data set to a device configured to train or use a model to make predictions based on the observation data set.

27. A computer-implemented method, the method comprising:
registering source data from a plurality of data sources;
populating a feature catalog, wherein populating the feature catalog includes generating a plurality of features based on the source data, wherein generating each feature in the plurality of features comprises applying one or more data transformations associated with the feature to a respective subset of the source data; and
for each feature in the feature catalog:
determining one or more signal types of the feature based at least in part on data indicating semantic types of one or more fields of the source data used to generate the feature and the one or more data transformations associated with the feature, wherein the semantic types of the one or more fields are selected from a plurality of semantic types defined by a data ontology; and
associating the feature with the one or more signal types in the feature catalog.
